(19) United States
(12) Patent Application Publication
(10) Pub. No.: US 2018/0054289 A1
(43) Pub. Date: Feb. 22, 2018

(54) METHOD AND APPARATUS FOR TRANSCEIVING PHYSICAL BROADCAST CHANNEL IN WIRELESS ACCESS SYSTEM SUPPORTING MACHINE-TYPE COMMUNICATION

(71) Applicant: LG ELECTRONICS INC., Seoul (KR)

(72) Inventors: Bonghoe KIM, Seoul (KR); Yunjung YI, Seoul (KR)

(73) Assignee: LG ELECTRONICS INC., Seoul (KR)

(21) Appl. No.: 15/550,248

(22) PCT Filed: Feb. 5, 2016
(86) PCT No.: PCT/KR2016/001324

§ 371 Date: Aug. 10, 2017

Related U.S. Application Data
(60) Provisional application No. 62/114,085, filed on Feb. 10, 2015.
(60) Provisional application No. 62/161,911, filed on May 15, 2015.

(51) Int. Cl. H04L 5/00; H04W 4/00; H04B 7/26

(52) U.S. Cl. CPC H04L 5/0053; H04W 4/006; H04B 7/0626; H04B 7/2612; H04L 5/0048; H04B 7/2603

(57) ABSTRACT

The present invention relates to a wireless access system supporting a machine-type communication (MTC), and particularly, provided are a method for repeatedly transmitting a physical broadcast channel (PBCH) for an MTC, and apparatus for supporting same. The method for repeatedly transmitting a PBCH for an MTC terminal in a wireless access system supporting MTC according to one embodiment of the present invention may comprise the steps of: transmitting a first PBCH by means of a legacy PBCH transmission region of a first subframe; repeatedly transmitting a second PBCH from the first subframe; and repeatedly transmitting a third PBCH from a second subframe. Here, the present invention can be structured so that the second PBCH and third PBCH are not repeatedly transmitted in the control regions of the first subframe and second subframe.

### TECHNICAL FIELD

The present invention relates to a wireless access system supporting machine type communication (MTC), and more particularly, to a method and apparatus for repeatedly transmitting and receiving a physical broadcast channel (PBCH) for an MTC user equipment (UE).

### BACKGROUND ART

Wireless access systems have been widely deployed to provide various types of communication services such as voice or data. In general, a wireless access system is a multiple access system that supports communication of multiple users by sharing available system resources (a bandwidth, transmission power, etc.) among them. For example, multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, and a Single Carrier Frequency Division Multiple Access (SC-FDMA) system.

### DISCLOSURE OF THE INVENTION

### Technical Task

An object of the present invention is to provide a method for configuring a PBCH for an MTC UE.

Another object of the present invention is to provide a method for repeatedly transmitting control information carried through a PBCH for an MTC UE.

A further object of the present invention is to provide an apparatus for supporting the above-described methods.

It will be appreciated by persons skilled in the art that the objects that could be achieved with the present invention are not limited to what has been particularly described hereinabove and the above and other objects that the present invention could achieve will be more clearly understood from the following detailed description.

### Technical Solutions

The present invention relates to a wireless access system supporting machine type communication (MTC). In particular, the invention provides a method for repeatedly transmitting a physical broadcast channel (PBCH) for MTC and apparatus for supporting the same.

In an aspect of the present invention, provided herein is a method for repeatedly transmitting a physical broadcast channel (PBCH) for a machine type communication (MTC) user equipment (UE) in a wireless access system supporting MTC, including: transmitting a first PBCH in a legacy PBCH transmission region of a first subframe; repeatedly transmitting a second PBCH in the first subframe; and repeatedly transmitting a third PBCH in a second subframe. In this case, the second and third PBCHs may be configured not to be repeatedly transmitted in control regions of the first and second subframes.

In another aspect of the present invention, provided herein is a base station (BS) for repeatedly transmitting a physical broadcast channel (PBCH) for a machine type communication (MTC) user equipment (UE) in a wireless access system supporting MTC, including: a transmitter; and a processor configured to support the repeated PBCH transmission. In this case, the processor may be configured to control the transmitter to: transmit a first PBCH in a legacy PBCH transmission region of a first subframe; repeatedly transmit a second PBCH in the first subframe; and repeatedly transmit a third PBCH in a second subframe. In addition, the second and third PBCHs may be configured not to be repeatedly transmitted in control regions of the first and second subframes.

Each of the control regions may be allocated across symbols from a first symbol to either a third or fourth symbol of a first slot of each of the first and second subframes.

In the second frame, the third PBCH may not be allocated to a resource element (RE) to which a reference signal (RS) is allocated. In this case, the RS may be a channel state information-reference signal (CSI-RS) and the RE may be an RE to which a CSI-RS mapped to a CSI-RS configuration which is commonly used in frequency division multiplexing (FDD) and time division multiplexing (TDD) schemes among CSI-RS configurations is allocated. In addition, the RE may be allocated to sixth and seventh symbols in a first slot of the second subframe and the RE may be allocated to third and fourth symbols or sixth and seventh symbols in a second slot of the second subframe.

The second PBCH may be transmitted in an MTC transmission region for the MTC UE of the first subframe and the third PBCH may be transmitted in an MTC transmission region for the MTC UE of the second subframe.

The first and second subframes may be consecutive subframes.

The aforementioned aspects of the present invention are merely a part of preferred embodiments of the present invention. Those skilled in the art will derive and understand various embodiments reflecting the technical features of the present invention from the following detailed description of the present invention.

### Advantageous Effects

According to embodiments of the present invention, the present invention has the following effects.

First, a PBCH can be reliably transmitted to MTC UEs in a poor environment.

Second, system information for an MTC UE can be efficiently transmitted without any impact on a legacy UE by defining a new MTC PBCH which is relatedly transmitted for the MTC UE.

Third, a constant phase difference value can be achieved by repeatedly transmitting the same PBCH encoding bit block in the same radio frame, whereby a Base Station (BS) and/or an MTC UE can efficiently and accurately perform frequency tracking and/or frequency offset estimation.

It will be appreciated by persons skilled in the art that that the effects that can be achieved through the embodiments of the present invention are not limited to those described above and other advantages of the present invention will be more clearly understood from the following detailed description. That is, unintended effects according to practice of the present invention may be derived from the embodiments of the present invention by those skilled in the art.

### DESCRIPTION OF DRAWINGS

The accompanying drawings, which are included to provide a further understanding of the invention, illustrate embodiments of the invention and together with the description serve to explain the principle of the invention. In the drawings:

FIG. 1 illustrates physical channels and a general signal transmission method using the physical channels, which may be used in embodiments of the present invention;

FIG. 2 illustrates radio frame structures used in embodiments of the present invention;

FIG. 3 illustrates a structure of a DownLink (DL) resource grid for the duration of one DL slot, which may be used in embodiments of the present invention;

FIG. 4 illustrates a structure of an UpLink (UL) subframe, which may be used in embodiments of the present invention;

FIG. 5 illustrates a structure of a DL subframe, which may be used in embodiments of the present invention;

FIG. 6 illustrates a cross carrier-scheduled subframe structure in the LTE-A system, which is used in embodiments of the present invention;

FIG. 7 is a diagram showing an example of an initial access procedure used in an LTE/LTE-A system;

FIG. 8 is a diagram showing one method for transmitting a broadcast channel signal;

FIG. 9 is a conceptual diagram of a CoMP system operating in a CA environment;

FIG. 10 is a diagram illustrating an exemplary subframe to which a Cell specific Reference Signal (CRS) that can be used in embodiments of the present invention is allocated;

FIG. 11 is a diagram illustrating exemplary subframes to which CSI-RSs that can be used in embodiments of the present invention are allocated according to the number of antenna ports;

FIG. 12 is a diagram illustrating an example of multiplexing a legacy PDCCH, a PDSCH, and an E-PDCCH used in the LTE/LTE-A system;

FIG. 13 is a diagram for explaining a method performed by a BS for repeatedly transmitting a PBCH to an MTC UE;

FIG. 14 is a diagram for explaining a method for repeatedly transmitting an MTC PBCH to an MTC UE; and

FIG. 15 illustrates apparatuses for implementing the methods described with reference to FIGS. 1 to 14.

### BEST MODE FOR INVENTION

In the embodiments of the present invention, which will be described in detail below, a method and device for using a heterogeneous network signal to measure a position of a UE are provided.

The embodiments of the present invention described below are combinations of elements and features of the present invention in specific forms. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions or elements of any one embodiment may be included in another embodiment and may be replaced with corresponding constructions or features of another embodiment.

In the description of the attached drawings, a detailed description of known procedures or steps of the present invention will be avoided lest it should obscure the subject matter of the present invention. In addition, procedures or steps that could be understood to those skilled in the art will not be described either.

In the disclosure, ‘include’ or ‘comprise’ should be interpreted as that other components may further be included, not excluded, unless otherwise specified. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present invention, a description is mainly made of a data transmission and reception relationship between a Base Station (BS) and a User Equipment (UE). A BS refers to a terminal node of a network, which directly communicates with a UE. A specific operation described as being performed by the BS may be performed by an upper node of the BS.

Namely, it is apparent that, in a network comprised of a plurality of network nodes including a BS, various operations performed for communication with a UE may be performed by the BS, or network nodes other than the BS. The term ‘BS’ may be replaced with a fixed station, a Node B, an evolved Node B (eNode B or eNB), an Advanced Base Station (ABS), an access point, etc.

In the embodiments of the present invention, the term terminal may be replaced with a UE, a Mobile Station (MS), a Subscriber Station (SS), a Mobile Subscriber Station (MSS), a mobile terminal, an Advanced Mobile Station (AMS), etc.

A transmitter is a fixed and/or mobile node that provides a data service or a voice service and a receiver is a fixed and/or mobile node that receives a data service or a voice service. Therefore, a UE may serve as a transmitter and a BS may serve as a receiver, on an UpLink (UL). Likewise, the UE may serve as a receiver and the BS may serve as a transmitter, on a DL.

The embodiments of the present invention may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, and a 3GPP2 system. In particular, the embodiments of the present invention may be supported by the standard specifications, 3GPP TS 36.211, 3GPP TS 36.212, 3GPP TS 36.213, and 3GPP TS 36.321. That is, the steps or parts, which are not described to clearly reveal the technical idea of the present invention, in the embodiments of the present invention may be explained by the above standard specifications. All terms used in the embodiments of the present invention may be explained by the standard specifications.

Reference will now be made in detail to the preferred embodiments of the present invention with reference to the accompanying drawings. The detailed description, which will be given below with reference to the accompanying drawings, is intended to explain exemplary embodiments of the present invention, rather than to show the only embodiments that can be implemented according to the invention.

The following detailed description includes specific terms in order to provide a thorough understanding of the present invention. However, it will be apparent to those skilled in the art that the specific terms may be replaced with other terms without departing the technical spirit and scope of the present invention.

Hereinafter, as an example of the wireless access system to which the embodiments of the present invention can be applied, the 3GPP LTE/LTE-A system will be described.

The embodiments of the present invention can be applied to various wireless access systems such as Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), etc.

CDMA may be implemented as a radio technology such as Universal Terrestrial Radio Access (UTRA) or CDMA2000. TDMA may be implemented as a radio technology such as Global System for Mobile communications (GSM)/General packet Radio Service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, Evolved UTRA (E-UTRA), etc.

UTRA is a part of Universal Mobile Telecommunications System (UMTS). 3GPP LTE is a part of Evolved UMTS (E-UMTS) using E-UTRA, adopting OFDMA for DL and SC-FDMA for UL. LTE-Advanced (LTE-A) is an evolution of 3GPP LTE. While the embodiments of the present invention are described in the context of a 3GPP LTE/LTE-A system in order to clarify the technical features of the present invention, the present invention is also applicable to an IEEE 802.16e/m system, etc.

1. 3GPP LTE/LTE-A System

In a wireless access system, a UE receives information from an eNB on a DL and transmits information to the eNB on a UL. The information transmitted and received between the UE and the eNB includes general data information and various types of control information. There are many physical channels according to the types/usages of information transmitted and received between the eNB and the UE.

1.1 System Overview

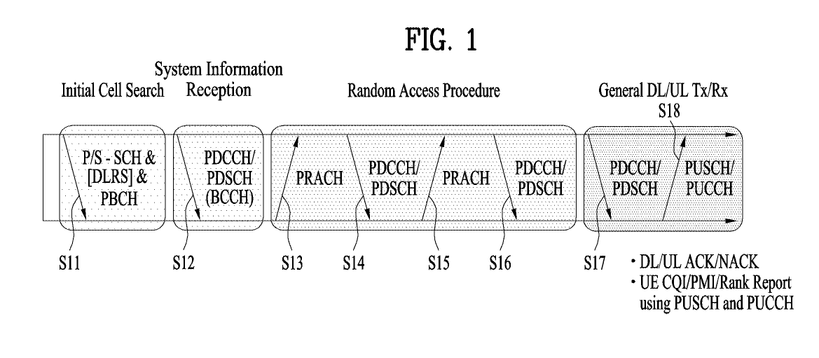

FIG. 1 illustrates physical channels and a general method using the physical channels, which may be used in embodiments of the present invention.

When a UE is powered on or enters a new cell, the UE performs initial cell search (511). The initial cell search involves acquisition of synchronization to an eNB. Specifically, the UE synchronizes its timing to the eNB and acquires information such as a cell Identifier (ID) by receiving a Primary Synchronization Channel (P-SCH) and a Secondary Synchronization Channel (S-SCH) from the eNB.

Then the UE may acquire information broadcast in the cell by receiving a Physical Broadcast Channel (PBCH) from the eNB.

During the initial cell search, the UE may monitor a DL channel state by receiving a Downlink Reference Signal (DL RS).

After the initial cell search, the UE may acquire more detailed system information by receiving a Physical Downlink Control Channel (PDCCH) and receiving a Physical Downlink Shared Channel (PDSCH) based on information of the PDCCH (S12).

To complete connection to the eNB, the UE may perform a random access procedure with the eNB (S13 to S16). In the random access procedure, the UE may transmit a preamble on a Physical Random Access Channel (PRACH) (S13) and may receive a PDCCH and a PDSCH associated with the PDCCH (S14). In the case of contention-based random access, the UE may additionally perform a contention resolution procedure including transmission of an additional PRACH (S15) and reception of a PDCCH signal and a PDSCH signal corresponding to the PDCCH signal (S16).

After the above procedure, the UE may receive a PDCCH and/or a PDSCH from the eNB (S17) and transmit a Physical Uplink Shared Channel (PUSCH) and/or a Physical Uplink Control Channel (PUCCH) to the eNB (S18), in a general UL/DL signal transmission procedure.

Control information that the UE transmits to the eNB is generically called Uplink Control Information (UCI). The UCI includes a Hybrid Automatic Repeat and reQuest Acknowledgement/Negative Acknowledgement (HARQ-ACK/NACK), a Scheduling Request (SR), a Channel Quality Indicator (CQI), a Precoding Matrix Index (PMI), a Rank Indicator (RI), etc.

In the LTE system, UCI is generally transmitted on a PUCCH periodically. However, if control information and traffic data should be transmitted simultaneously, the control information and traffic data may be transmitted on a PUSCH. In addition, the UCI may be transmitted aperiodically on the PUSCH, upon receipt of a request/command from a network.

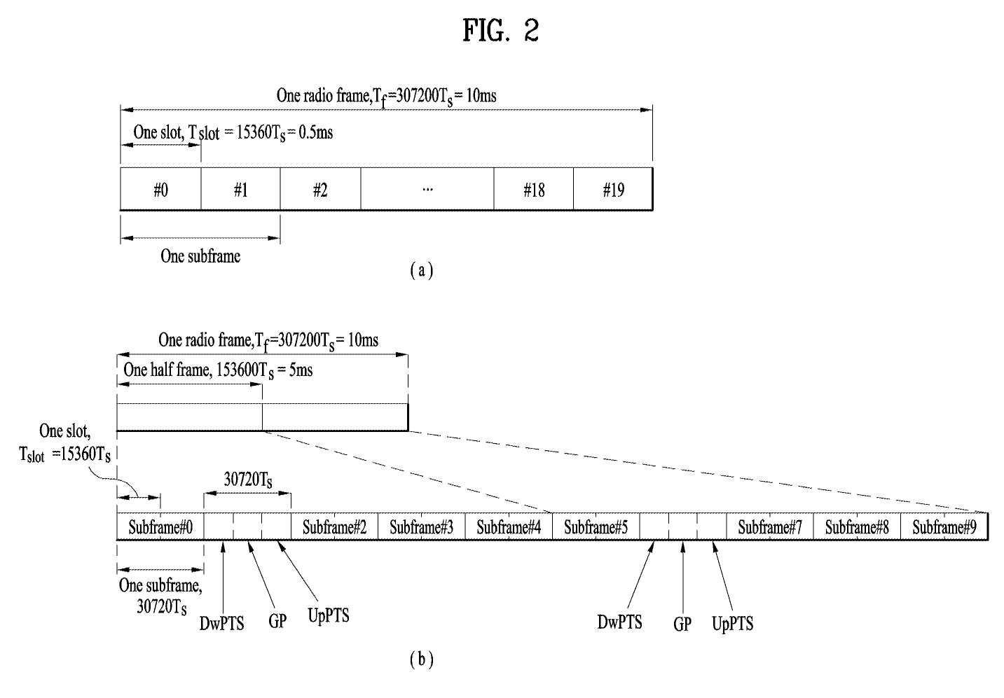

FIG. 2 illustrates exemplary radio frame structures used in embodiments of the present invention.

FIG. 2(a) illustrates frame structure type 1. Frame structure type 1 is applicable to both a full Frequency Division Duplex (FDD) system and a half FDD system.

One radio frame is 10 ms (T_{f}=307200·Tₛ) long, including equal-sized 20 slots indexed from 0 to 19. Each slot is 0.5 ms (Tₛₗₒₜ=15360·Tₛ) long. One subframe includes two successive slots. An i^{th} subframe includes 2i^{th} and (2i+1)^{th} slots. That is, a radio frame includes 10 subframes. A time required for transmitting one subframe is defined as a Transmission Time Interval (TTI). Ts is a sampling time given as Tₛ=1/(15 kHz×2048)=3.2552×10⁻⁸ (about 33 ns). One slot includes a plurality of Orthogonal Frequency Division Multiplexing (OFDM) symbols or SC-FDMA symbols in the time domain by a plurality of Resource Blocks (RBs) in the frequency domain.

A slot includes a plurality of OFDM symbols in the time domain. Since OFDMA is adopted for DL in the 3GPP LTE system, one OFDM symbol represents one symbol period. An OFDM symbol may be called an SC-FDMA symbol or symbol period. An RB is a resource allocation unit including a plurality of contiguous subcarriers in one slot.

In a full FDD system, each of 10 subframes may be used simultaneously for DL transmission and UL transmission during a 10-ms duration. The DL transmission and the UL transmission are distinguished by frequency. On the other hand, a UE cannot perform transmission and reception simultaneously in a half FDD system.

The above radio frame structure is purely exemplary. Thus, the number of subframes in a radio frame, the number of slots in a subframe, and the number of OFDM symbols in a slot may be changed.

FIG. 2(b) illustrates frame structure type 2. Frame structure type 2 is applied to a Time Division Duplex (TDD) system. One radio frame is 10 ms (T_{f}=307200·Tₛ) long, including two half-frames each having a length of 5 ms (=153600·Tₛ) long. Each half-frame includes five subframes each being 1 ms (=30720·Tₛ) long. An i^{th} subframe includes 2i^{th} and (2i+1)^{th} slots each having a length of 0.5 ms (Tₛₗₒₜ=15360·Tₛ). Tₛ is a sampling time given as Tₛ=1/(15 kHz×2048)=3.2552×10⁻⁸ (about 33 ns).

A type-2 frame includes a special subframe having three fields, Downlink Pilot Time Slot (DwPTS), Guard Period (GP), and Uplink Pilot Time Slot (UpPTS). The DwPTS is used for initial cell search, synchronization, or channel estimation at a UE, and the UpPTS is used for channel estimation and UL transmission synchronization with a UE at an eNB. The GP is used to cancel UL interference between a UL and a DL, caused by the multi-path delay of a DL signal.

[Table 1] below lists special subframe configurations (DwPTS/GP/UpPTS lengths).

TABLE 1

| | Normal cyclic prefix in downlink | | | Extended cyclic prefix in downlink | | |
|---|---|---|---|---|---|---|
| | | UpPTS | | | UpPTS | |
| Special | | Normal | Extended | | Normal | Extended |
| subframe | | cyclic prefix | cyclic prefix | | cyclic prefix | cyclic prefix |
| configuration | DwPTS | in uplink | in uplink | DwPTS | in uplink | in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | — | — |
| 8 | 24144 · Tₛ | | | — | — | — |

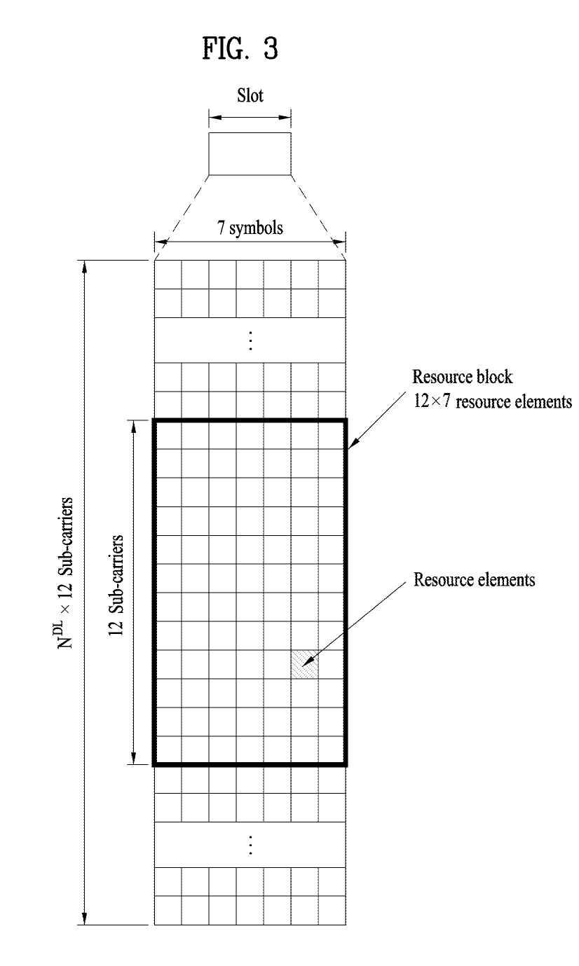

FIG. 3 illustrates an exemplary structure of a DL resource grid for the duration of one DL slot, which may be used in embodiments of the present invention.

Referring to FIG. 3, a DL slot includes a plurality of OFDM symbols in the time domain. One DL slot includes 7 OFDM symbols in the time domain and an RB includes 12 subcarriers in the frequency domain, to which the present invention is not limited.

Each element of the resource grid is referred to as a Resource Element (RE). An RB includes 12×7 REs. The number of RBs in a DL slot, NDL depends on a DL transmission bandwidth. A UL slot may have the same structure as a DL slot.

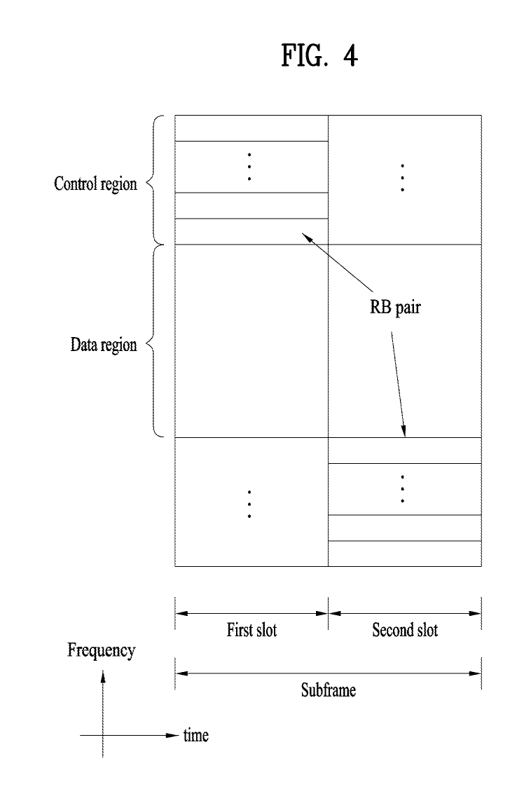

FIG. 4 illustrates a structure of a UL subframe which may be used in embodiments of the present invention.

Referring to FIG. 4, a UL subframe may be divided into a control region and a data region in the frequency domain. A PUCCH carrying UCI is allocated to the control region and a PUSCH carrying user data is allocated to the data region. To maintain a single carrier property, a UE does not transmit a PUCCH and a PUSCH simultaneously. A pair of RBs in a subframe are allocated to a PUCCH for a UE. The RBs of the RB pair occupy different subcarriers in two slots. Thus it is said that the RB pair frequency-hops over a slot boundary.

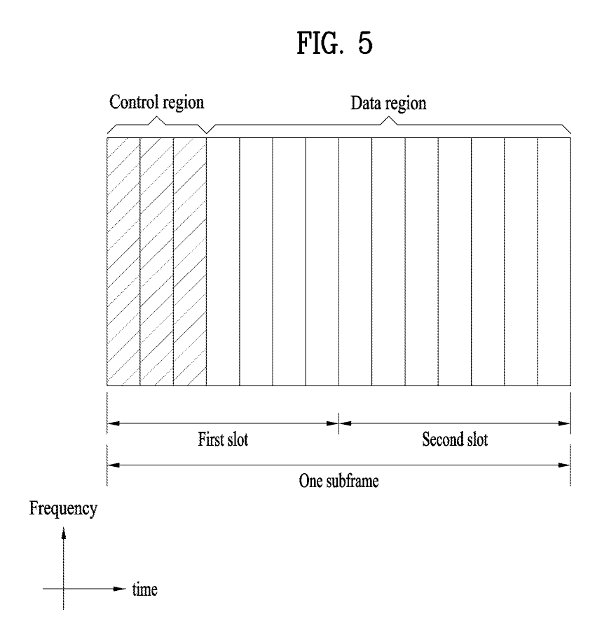

FIG. 5 illustrates a structure of a DL subframe that may be used in embodiments of the present invention.

Referring to FIG. 5, up to three OFDM symbols of a DL subframe, starting from OFDM symbol 0 are used as a control region to which control channels are allocated and the other OFDM symbols of the DL subframe are used as a data region to which a PDSCH is allocated. DL control channels defined for the 3GPP LTE system include a Physical Control Format Indicator Channel (PCFICH), a PDCCH, and a Physical Hybrid ARQ Indicator Channel (PHICH).

The PCFICH is transmitted in the first OFDM symbol of a subframe, carrying information about the number of OFDM symbols used for transmission of control channels (i.e. the size of the control region) in the subframe. The PHICH is a response channel to a UL transmission, delivering an HARQ ACK/NACK signal. Control information carried on the PDCCH is called Downlink Control Information (DCI). The DCI transports UL resource assignment information, DL resource assignment information, or UL Transmission (Tx) power control commands for a UE group.

2. Carrier Aggregation (CA) Environment

2.1 CA Overview

A 3GPP LTE system (conforming to Rel-8 or Rel-9) (hereinafter, referred to as an LTE system) uses Multi-Carrier Modulation (MCM) in which a single Component Carrier (CC) is divided into a plurality of bands. In contrast, a 3GPP LTE-A system (hereinafter, referred to an LTE-A system) may use CA by aggregating one or more CCs to support a broader system bandwidth than the LTE system. The term CA is interchangeably used with carrier combining, multi-CC environment, or multi-carrier environment.

In the present invention, multi-carrier means CA (or carrier combining). Herein, CA covers aggregation of contiguous carriers and aggregation of non-contiguous carriers. The number of aggregated CCs may be different for a DL and a UL. If the number of DL CCs is equal to the number of UL CCs, this is called symmetric aggregation. If the number of DL CCs is different from the number of UL CCs, this is called asymmetric aggregation. The term CA is interchangeable with carrier combining, bandwidth aggregation, spectrum aggregation, etc.

The LTE-A system aims to support a bandwidth of up to 100 MHz by aggregating two or more CCs, that is, by CA. To guarantee backward compatibility with a legacy IMT system, each of one or more carriers, which has a smaller bandwidth than a target bandwidth, may be limited to a bandwidth used in the legacy system.

For example, the legacy 3GPP LTE system supports bandwidths {1.4, 3, 5, 10, 15, and 20 MHz} and the 3GPP LTE-A system may support a broader bandwidth than 20 MHz using these LTE bandwidths. A CA system of the present invention may support CA by defining a new bandwidth irrespective of the bandwidths used in the legacy system.

There are two types of CA, intra-band CA and inter-band CA. Intra-band CA means that a plurality of DL CCs and/or UL CCs are successive or adjacent in frequency. In other words, the carrier frequencies of the DL CCs and/or UL CCs are positioned in the same band. On the other hand, an environment where CCs are far away from each other in frequency may be called inter-band CA. In other words, the carrier frequencies of a plurality of DL CCs and/or UL CCs are positioned in different bands. In this case, a UE may use a plurality of Radio Frequency (RF) ends to conduct communication in a CA environment.

The LTE-A system adopts the concept of cell to manage radio resources. The above-described CA environment may be referred to as a multi-cell environment. A cell is defined as a pair of DL and UL CCs, although the UL resources are not mandatory. Accordingly, a cell may be configured with DL resources alone or DL and UL resources.

For example, if one serving cell is configured for a specific UE, the UE may have one DL CC and one UL CC. If two or more serving cells are configured for the UE, the UE may have as many DL CCs as the number of the serving cells and as many UL CCs as or fewer UL CCs than the number of the serving cells, or vice versa. That is, if a plurality of serving cells are configured for the UE, a CA environment using more UL CCs than DL CCs may also be supported.

CA may be regarded as aggregation of two or more cells having different carrier frequencies (center frequencies). Herein, the term ‘cell’ should be distinguished from ‘cell’ as a geographical area covered by an eNB. Hereinafter, intra-band CA is referred to as intra-band multi-cell and inter-band CA is referred to as inter-band multi-cell.

In the LTE-A system, a Primacy Cell (PCell) and a Secondary Cell (SCell) are defined. A PCell and an SCell may be used as serving cells. For a UE in RRC_CONNECTED state, if CA is not configured for the UE or the UE does not support CA, a single serving cell including only a PCell exists for the UE. On the contrary, if the UE is in RRC_CONNECTED state and CA is configured for the UE, one or more serving cells may exist for the UE, including a PCell and one or more SCells.

Serving cells (PCell and SCell) may be configured by an RRC parameter. A physical-layer ID of a cell, PhysCellId is an integer value ranging from 0 to 503. A short ID of an SCell, SCellIndex is an integer value ranging from 1 to 7. A short ID of a serving cell (PCell or SCell), ServeCellIndex is an integer value ranging from 1 to 7. If ServeCellIndex is 0, this indicates a PCell and the values of ServeCellIndex for SCells are pre-assigned. That is, the smallest cell ID (or cell index) of ServeCellIndex indicates a PCell.

A PCell refers to a cell operating in a primary frequency (or a primary CC). A UE may use a PCell for initial connection establishment or connection reestablishment. The PCell may be a cell indicated during handover. In addition, the PCell is a cell responsible for control-related communication among serving cells configured in a CA environment. That is, PUCCH allocation and transmission for the UE may take place only in the PCell. In addition, the UE may use only the PCell in acquiring system information or changing a monitoring procedure. An Evolved Universal Terrestrial Radio Access Network (E-UTRAN) may change only a PCell for a handover procedure by a higher-layer RRCConnectionReconfiguration message including mobilityControlInfo to a UE supporting CA.

An SCell may refer to a cell operating in a secondary frequency (or a secondary CC). Although only one PCell is allocated to a specific UE, one or more SCells may be allocated to the UE. An SCell may be configured after RRC connection establishment and may be used to provide additional radio resources. There is no PUCCH in cells other than a PCell, that is, in SCells among serving cells configured in the CA environment.

When the E-UTRAN adds an SCell to a UE supporting CA, the E-UTRAN may transmit all system information related to operations of related cells in RRC_CONNECTED state to the UE by dedicated signaling. Changing system information may be controlled by releasing and adding a related SCell. Herein, a higher-layer RRCConnectionReconfiguration message may be used. The E-UTRAN may transmit a dedicated signal having a different parameter for each cell rather than it broadcasts in a related SCell.

After an initial security activation procedure starts, the E-UTRAN may configure a network including one or more SCells by adding the SCells to a PCell initially configured during a connection establishment procedure. In the CA environment, each of a PCell and an SCell may operate as a CC. Hereinbelow, a Primary CC (PCC) and a PCell may be used in the same meaning and a Secondary CC (SCC) and an SCell may be used in the same meaning in embodiments of the present invention.

2.2 Cross Carrier Scheduling

Two scheduling schemes, self-scheduling and cross carrier scheduling are defined for a CA system, from the perspective of carriers or serving cells. Cross carrier scheduling may be called cross CC scheduling or cross cell scheduling.

In self-scheduling, a PDCCH (carrying a DL grant) and a PDSCH are transmitted in the same DL CC or a PUSCH is transmitted in a UL CC linked to a DL CC in which a PDCCH (carrying a UL grant) is received.

In cross carrier scheduling, a PDCCH (carrying a DL grant) and a PDSCH are transmitted in different DL CCs or a PUSCH is transmitted in a UL CC other than a UL CC linked to a DL CC in which a PDCCH (carrying a UL grant) is received.

Cross carrier scheduling may be activated or deactivated UE-specifically and indicated to each UE semi-statically by higher-layer signaling (e.g. RRC signaling).

If cross carrier scheduling is activated, a Carrier Indicator Field (CIF) is required in a PDCCH to indicate a DL/UL CC in which a PDSCH/PUSCH indicated by the PDCCH is to be transmitted. For example, the PDCCH may allocate PDSCH resources or PUSCH resources to one of a plurality of CCs by the CIF. That is, when a PDCCH of a DL CC allocates PDSCH or PUSCH resources to one of aggregated DL/UL CCs, a CIF is set in the PDCCH. In this case, the DCI formats of LTE Release-8 may be extended according to the CIF. The CIF may be fixed to three bits and the position of the CIF may be fixed irrespective of a DCI format size. In addition, the LTE Release-8 PDCCH structure (the same coding and resource mapping based on the same CCEs) may be reused.

On the other hand, if a PDCCH transmitted in a DL CC allocates PDSCH resources of the same DL CC or allocates PUSCH resources in a single UL CC linked to the DL CC, a CIF is not set in the PDCCH. In this case, the LTE Release-8 PDCCH structure (the same coding and resource mapping based on the same CCEs) may be used.

If cross carrier scheduling is available, a UE needs to monitor a plurality of PDCCHs for DCI in the control region of a monitoring CC according to the transmission mode and/or bandwidth of each CC. Accordingly, an appropriate SS configuration and PDCCH monitoring are needed for the purpose.

In the CA system, a UE DL CC set is a set of DL CCs scheduled for a UE to receive a PDSCH, and a UE UL CC set is a set of UL CCs scheduled for a UE to transmit a PUSCH. A PDCCH monitoring set is a set of one or more DL CCs in which a PDCCH is monitored. The PDCCH monitoring set may be identical to the UE DL CC set or may be a subset of the UE DL CC set. The PDCCH monitoring set may include at least one of the DL CCs of the UE DL CC set. Or the PDCCH monitoring set may be defined irrespective of the UE DL CC set. DL CCs included in the PDCCH monitoring set may be configured to always enable self-scheduling for UL CCs linked to the DL CCs. The UE DL CC set, the UE UL CC set, and the PDCCH monitoring set may be configured UE-specifically, UE group-specifically, or cell-specifically.

If cross carrier scheduling is deactivated, this implies that the PDCCH monitoring set is always identical to the UE DL CC set. In this case, there is no need for signaling the PDCCH monitoring set. However, if cross carrier scheduling is activated, the PDCCH monitoring set is preferably defined within the UE DL CC set. That is, the eNB transmits a PDCCH only in the PDCCH monitoring set to schedule a PDSCH or PUSCH for the UE.

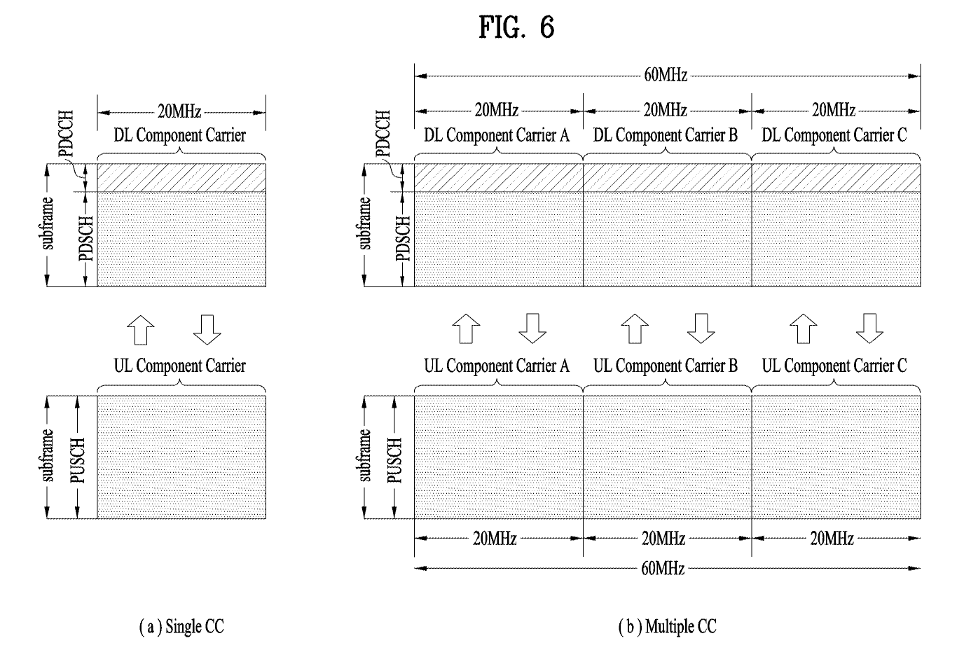

FIG. 6 illustrates a cross carrier-scheduled subframe structure in the LTE-A system, which is used in embodiments of the present invention.

Referring to FIG. 6, three DL CCs are aggregated for a DL subframe for LTE-A UEs. DL CC ‘A’ is configured as a PDCCH monitoring DL CC. If a CIF is not used, each DL CC may deliver a PDCCH that schedules a PDSCH in the same DL CC without a CIF. On the other hand, if the CIF is used by higher-layer signaling, only DL CC ‘A’ may carry a PDCCH that schedules a PDSCH in the same DL CC ‘A’ or another CC. Herein, no PDCCH is transmitted in DL CC ‘B’ and DL CC ‘C’ that are not configured as PDCCH monitoring DL CCs.

3. Common Control Channel and Broadcast Channel Allocation Method

3.1 Initial Access Procedure

An initial access procedure may include a cell discovery procedure, a system information acquisition procedure and a random access procedure.

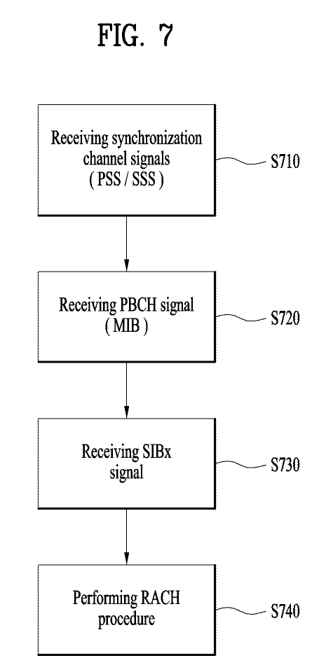

FIG. 7 is a diagram showing an example of an initial access procedure used in an LTE/LTE-A system.

A UE may receive synchronization signals (e.g., a primary synchronization signal (PSS) and a secondary synchronization signal (SSS)) transmitted from an eNB to acquire downlink synchronization information. The synchronization signals are transmitted twice per frame (at an interval of 10 ms). That is, the synchronization signals are transmitted at an interval of 5 ms (S710).

The downlink synchronization information acquired in step S710 may include a physical cell ID (PCID), downlink time and frequency synchronization and cyclic prefix (CP) length information.

Thereafter, the UE receives a physical broadcast channel (PBCH) signal transmitted via a PBCH. At this time, the PBCH signal is repeatedly transmitted four times in different scrambling sequences in four frames (that is, 40 ms) (S720).

The PBCH signal includes a master information block (MIB) as system information. One MIB has a total size of 24 bits and 14 bits thereof are used to indicate physical HARQ indicator channel (PHICH) configuration information, downlink cell bandwidth (dl-bandwidth) information and system frame number (SFN). The remaining 10 bits thereof are spare bits.

Thereafter, the UE may receive different system information blocks (SIBs) transmitted from the eNB to acquire the remaining system information. The SIBs are transmitted on a DL-SCH and presence/absence of the SIB is checked by a PDCCH signal masked with a system information radio network temporary identifier (SI-RNTI) (S730).

System information block type 1 (SIB1) of the SIBs includes parameters necessary to determine whether the cell is suitable for cell selection and information on scheduling of the other SIBs on a time axis. System information block type 2 (SIB2) includes common channel information and shared channel information. SIB3 to SIB8 include cell reselection related information, inter-frequency information, intra-frequency information, etc. SIB9 is used to deliver the name of a home eNodeB (HeNB) and SIB10 to SIB12 include an Earthquake and Tsunami Warning Service (ETWS) notification and a commercial mobile alert system (CMAS) message. SIB13 includes MBMS related control information.

The UE may perform the random access procedure when steps S710 to S730 are performed. In particular, the UE may acquire parameters for transmitting a physical random access channel (PRACH) signal upon receiving SIB2 of the above-described SIBs. Accordingly, the UE may generate and transmit a PRACH signal using the parameters included in SIB2 to perform the random access procedure with the eNB (S740).

3.2 Physical Broadcast Channel (PBCH)

In an LTE/LTE-A system, a PBCH is used for MIB transmission. Hereinafter, a method for configuring a PBCH will be described.

A block of bits b(0), . . . , b(M_{bit}−1) is scrambled with a cell-specific sequence prior to modulation to calculate a block of scrambled bits \tilde{b}(0), . . . , \tilde{b}(M_{bit}−1). At this time, M_{bit} denotes the number of bits transmitted on the PBCH and is 1920 bits for normal cyclic prefix and 1728 bits for extended cyclic prefix.

Equation 1 below shows one of methods for scrambling the block of bits.

\tilde{b}(i)=(b(i)+c(i))mod 2 [Equation 1]

In Equation 1, c(i) denotes a scrambling sequence. The scrambling sequence is initialized with cᵢₙᵢₜ=N_{ID}^{cell} in each radio frame fulfilling n_{f} mod 4=0.

The block of scrambled bits \tilde{b}(0), . . . , b(M_{bit}−1) is modulated to calculate a block of complex-valued modulation symbols d(0), . . . , d(M_{symb}−1). At this time, a modulation scheme applicable to a physical broadcast channel is quadrature phase shift keying (QPSK).

The block of modulation symbols d(0), . . . , d(M_{symb}−1) is mapped to one or more layers. At this time, M_{symb}⁽⁰⁾=M_{symb}. Thereafter, the block of modulation symbols is precoded to calculate a block of vectors y(i)=[y⁽⁰⁾(i) . . . y^{(p-1)}(i)]^{T}. At this time, i=0, . . . , M_{symb}−1. In addition, y^{(p)}(i) denotes a signal for an antenna port p, where p=0, . . . , P−1 and Pε{1,2,4}. p denotes the number of an antenna port for a cell-specific reference signal.

The block of complex-valued symbols y^{(p)}(0), . . . , y^{(p)}(M_{symb}−1) for each antenna port is transmitted during 4 consecutive radio frames starting in each radio frame fulfilling n_{f} mod 4=0. In addition, the block of complex-valued symbols is mapped to resource elements (k, l) not reserved for transmission of reference signals in increasing order of first the index k, then the index l of slot 1 of subframe 0 and finally the radio frame number. The resource element indices are given in Equation 2.

$$k = \frac{{N}_{RB}^{DL} {N}_{sc}^{RB}}{2} - 36 + {k}^{′} , {k}^{′} = 0 , 1 , … , 71 \\ l = 0 , 1 , … , 3 \qquad [ Equation 2 ]$$

Resource elements for reference signals are excluded from mapping. The mapping operation assumes that cell-specific reference signals for antenna ports 0 to 3 are present irrespective of the actual configuration. The UE assumes that the resource elements assumed to be reserved for reference signals in the mapping operation but not used for transmission of reference signals are not available for PDSCH transmission. The UE does not make any other assumptions about these resource elements.

3.3 MIB (Master Information Block)

The MIB is system information transmitted on a PBCH. That is, the MIB includes system information transmitted via a BCH. A signaling radio bearer is not applicable to the MIB, a radio link control-service access point (RLC-SAP) is in a transparent mode (TM), a logical channel is a broadcast control channel (BCCH), and the MIB is transmitted from an E-UTRAN to a UE. Table 2 below shows an example of an MIB format.

TABLE 2
-- ASN1START
MasterInformationBlock ::= SEQUENCE {

| | |
|---|---|
| dl-Bandwidth | ENUMERATED { |
| | n6, n15, n25, n50, n75, n100}, |
| phich-Config | PHICH-Config, |
| systemFrameNumber | BIT STRING (SIZE (8)), |
| spare | BIT STRING (SIZE (10)) |

}
-- ASN1STOP

The MIB includes a downlink bandwidth (dl-Bandwidth) parameter, a PHICH configuration (PHICH-config) parameter, a system frame number (systemFrameNumber) parameter and spare bits.

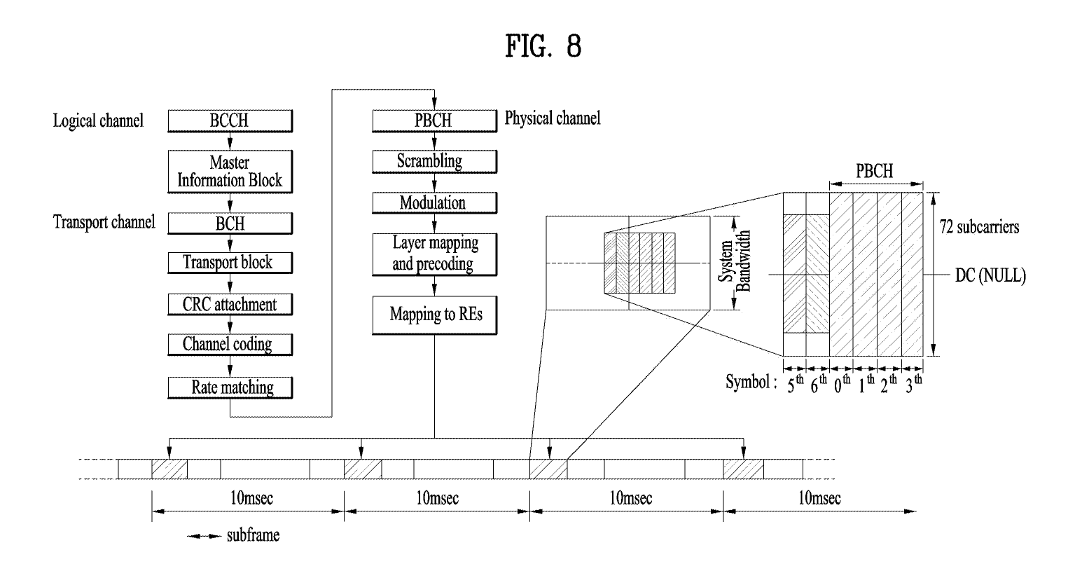

The downlink bandwidth parameter indicates 16 different transmission bandwidth configurations N_{RB}. For example, n6 corresponds to 6 resource blocks and n15 corresponds to 15 resource blocks. The PHICH configuration parameter indicates a PHICH configuration necessary to receive a control signal on a PDCCH necessary to receive a DL-SCH. The system frame number (SFN) parameter defines 8 most significant bits (MSBs) of the SFN. At this time, 2 least significant bits (LSBs) of the SFN are indirectly acquired via decoding of the PBCH. For example, timing of 40 ms PBCH TTI indicates 2 LSBs. This will be described in detail with reference to FIG. 8.

FIG. 8 is a diagram showing one method for transmitting a broadcast channel signal.

Referring to FIG. 8, an MIB transmitted via a BCCH, which is a logical channel, is delivered via a BCH which is a transport channel. At this time, the MIB is mapped to a transport block, and an MIB transport block is attached with CRC, is subjected to a channel coding and rate matching procedure and is delivered to a PBCH which is a physical channel. Thereafter, the MIB is subjected to scrambling and modulation procedures and a layer mapping and precoding procedure and then is mapped to a resource element (RE). That is, the same PBCH signal is scrambled and transmitted in different scrambling sequences during a period of 40 ms (that is, four frames). Accordingly, the UE may detect one PBCH every 40 ms via blind decoding and estimate the remaining 2 bits of the SFN.

For example, in a PBCH TTI of 40 ms, the LSB of the SFN is set to “00” when a PBCH signal is transmitted on a first radio frame, is set to “01” when the PBCH signal is transmitted on a second radio frame, is set to “10” when the PBCH signal is transmitted on a third radio frame, and is a set to “11” when the PBCH signal is transmitted on a last radio frame.

In addition, referring to FIG. 8, the PBCH may be allocated to 72 subcarriers located at the center of the first four OFDM symbols of a second slot (slot #1) of a first subframe (subframe #0) of each frame. At this time, a subcarrier region, to which the PBCH is allocated, is always a region corresponding to 72 center subcarriers irrespective of cell bandwidth. This allows detection of a PBCH even when downlink cell bandwidth is not known to the UE.

In addition, a primary synchronization channel (PSC), in which a primary synchronization signal (PSS) is transmitted, has a TTI of 5 ms and is allocated to a last symbol of a first slot (slot #0) of subframes #0 and #5 of each frame. A secondary synchronization channel (SSC), on which a secondary synchronization signal (SSS) is transmitted, has a TTI of 5 ms and is allocated to the second to last symbol (that is, a previous symbol of the PSS) of the same slot. In addition, the PSC and the SSC always occupy 72 center subcarriers irrespective of cell bandwidth and are allocated to 62 subcarriers.

3.4 CA Environment-Based CoMP Operation

Hereinafter, a cooperation multi-point (CoMP) transmission operation applicable to the embodiments of the present disclosure will be described.

In the LTE-A system, CoMP transmission may be implemented using a carrier aggregation (CA) function in the LTE. FIG. 8 is a conceptual view illustrating a CoMP system operating based on a CA environment.

In FIG. 8, it is assumed that a carrier operated as a PCell and a carrier operated as an SCell may use the same frequency band on a frequency axis and are allocated to two eNBs geographically spaced apart from each other. At this time, a serving eNB of UE1 may be allocated to the PCell, and a neighboring cell causing much interference may be allocated to the SCell. That is, the eNB of the PCell and the eNB of the SCell may perform various DL/UL CoMP operations such as joint transmission (JT), CS/CB and dynamic cell selection for one UE.

FIG. 8 illustrates an example that cells managed by two eNBs are aggregated as PCell and SCell with respect to one UE (e.g., UE1). However, as another example, three or more cells may be aggregated. For example, some cells of three or more cells may be configured to perform CoMP operation for one UE in the same frequency band, and the other cells may be configured to perform simple CA operation in different frequency bands. At this time, the PCell does not always need to participate in CoMP operation.

3.5 Reference Signal (RS)

Hereinafter, reference signals are explained, which are used for the embodiments of the present invention.

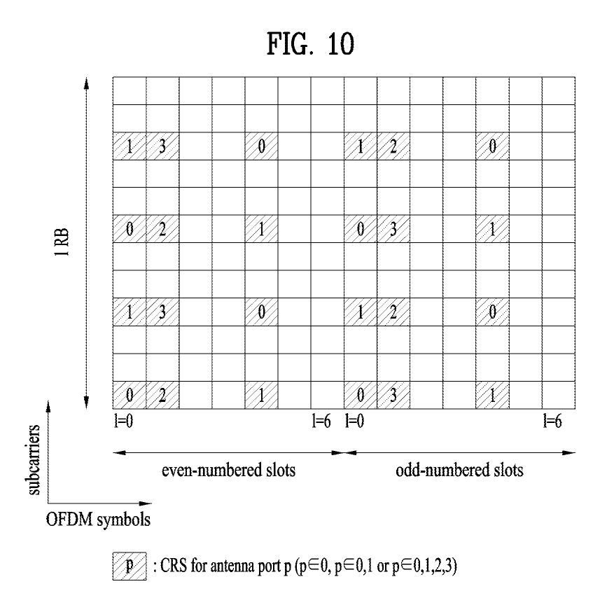

FIG. 10 illustrates a subframe to which CRSs are allocated, which may be used in embodiments of the present disclosure.

FIG. 10 represents an allocation structure of the CRS in case of the system supporting 4 antennas. Since CRSs are used for both demodulation and measurement, the CRSs are transmitted in all DL subframes in a cell supporting PDSCH transmission and are transmitted through all antenna ports configured at an eNB.

More specifically, CRS sequence is mapped to complex-modulation symbols used as reference symbols for antenna port p in slot ns.

A UE may measure CSI using the CRSs and demodulate a signal received on a PDSCH in a subframe including the CRSs. That is, the eNB transmits the CRSs at predetermined locations in each RB of all RBs and the UE performs channel estimation based on the CRSs and detects the PDSCH. For example, the UE may measure a signal received on a CRS RE and detect a PDSCH signal from an RE to which the PDSCH is mapped using the measured signal and using the ratio of reception energy per CRS RE to reception energy per PDSCH mapped RE.

When the PDSCH is transmitted based on the CRSs, since the eNB should transmit the CRSs in all RBs, unnecessary RS overhead occurs. To solve such a problem, in a 3GPP LTE-A system, a UE-specific RS (hereinafter, UE-RS) and a Channel State Information Reference Signal (CSI-RS) are further defined in addition to a CRS. The UE-RS is used for demodulation and the CSI-RS is used to derive CSI. The UE-RS is one type of a DRS.

Since the UE-RS and the CRS may be used for demodulation, the UE-RS and the CRS can be regarded as demodulation RSs in terms of usage. Since the CSI-RS and the CRS are used for channel measurement or channel estimation, the CSI-RS and the CRS can be regarded as measurement RSs.

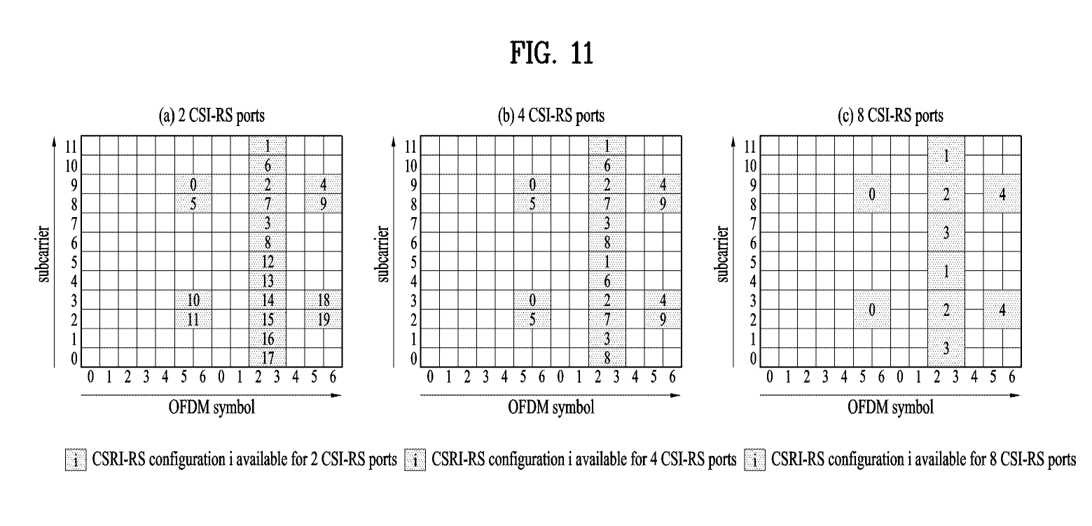

FIG. 11 illustrates channel state information reference signal (CSI-RS) configurations allocated according to the number of antenna ports, which may be used in embodiments of the present disclosure.

A CSI-RS is a DL RS that is introduced in a 3GPP LTE-A system for channel measurement rather than for demodulation. In the 3GPP LTE-A system, a plurality of CSI-RS configurations is defined for CSI-RS transmission. In subframes in which CSI-RS transmission is configured, CSI-RS sequence is mapped to complex modulation symbols used as RSs on antenna port p.

FIG. 11 (a) illustrates 20 CSI-RS configurations 0 to 19 available for CSI-RS transmission through two CSI-RS ports among the CSI-RS configurations, FIG. 11 (b) illustrates 10 available CSI-RS configurations 0 to 9 through four CSI-RS ports among the CSI-RS configurations, and FIG. 11 (c) illustrates 5 available CSI-RS configurations 0 to 4 through 8 CSI-RS ports among the CSI-RS configurations.

The CSI-RS ports refer to antenna ports configured for CSI-RS transmission. Since CSI-RS configuration differs according to the number of CSI-RS ports, if the numbers of antenna ports configured for CSI-RS transmission differ, the same CSI-RS configuration number may correspond to different CSI-RS configurations.

Unlike a CRS configured to be transmitted in every subframe, a CSI-RS is configured to be transmitted at a prescribed period corresponding to a plurality of subframes. Accordingly, CSI-RS configurations vary not only with the locations of REs occupied by CSI-RSs in an RB pair but also with subframes in which CSI-RSs are configured.

Meanwhile, if subframes for CSI-RS transmission differ even when CSI-RS configuration numbers are the same, CSI-RS configurations also differ. For example, if CSI-RS transmission periods (T_{CSI-RS}) differ or if start subframes (Δ_{CSI-RS}) in which CSI-RS transmission is configured in one radio frame differ, this may be considered as different CSI-RS configurations.

Hereinafter, in order to distinguish between a CSI-RS configuration to which (1) a CSI-RS configuration is assigned and (2) a CSI-RS configuration varying according to a CSI-RS configuration number, the number of CSI-RS ports, and/or a CSI-RS configured subframe, the CSI-RS configuration of the latter will be referred to as a CSI-RS resource configuration. The CSI-RS configuration of the former will be referred to as a CSI-RS configuration or CSI-RS pattern.

Upon informing a UE of the CSI-RS resource configuration, an eNB may inform the UE of information about the number of antenna ports used for transmission of CSI-RSs, a CSI-RS pattern, CSI-RS subframe configuration ICSI-RS, UE assumption on reference PDSCH transmitted power for CSI feedback Pc, a zero-power CSI-RS configuration list, a zero-power CSI-RS subframe configuration, etc.

CSI-RS subframe configuration I_{CSI-RS} is information for specifying subframe configuration periodicity T_{CSI-RS} and subframe offset Δ_{CSI-RS} regarding occurrence of the CSI-RSs. The following table 6 shows CSI-RS subframe configuration I_{CSI-RS} according to T_{CSI-RS} and Δ_{CSI-RS}.

TABLE 3

| CSI-RS- | CSI-RS periodicity | CSI-RS subframe offset |
|---|---|---|
| SubframeConfig I_{CSI-RS} | T_{CSI-RS} (subframes) | Δ_{CSI-RS} (subframes) |
| 0-4 | 5 | I_{CSI-RS} |
| 5-14 | 10 | I_{CSI-RS} − 5 |
| 15-34 | 20 | I_{CSI-RS} − 15 |
| 35-74 | 40 | I_{CSI-RS} − 35 |
| 75-154 | 80 | I_{CSI-RS} − 75 |

Subframes satisfying the following Equation 3 are subframes including CSI-RSs.

(10n_{f}+└nₛ/2┘−Δ_{CSI-RS})mod T_{CSI-RS}=0 [Equation 3]

A UE configured as transmission modes defined after introduction of the 3GPP LTE-A system (e.g. transmission mode 9 or other newly defined transmission modes) may perform channel measurement using a CSI-RS and decode a PDSCH using a UE-RS.

A UE configured as transmission modes defined after introduction of the 3GPP LTE-A system (e.g. transmission mode 9 or other newly defined transmission modes) may perform channel measurement using a CSI-RS and decode a PDSCH using a UE-RS.

3.6 Enhanced PDCCH (EPDCCH)

In the 3GPP LTE/LTE-A system, Cross-Carrier Scheduling (CCS) in an aggregation status for a plurality of component carriers (CC: component carrier=(serving) cell) will be defined. One scheduled CC may previously be configured to be DL/UL scheduled from another one scheduling CC (that is, to receive DL/UL grant PDCCH for a corresponding scheduled CC). At this time, the scheduling CC may basically perform DL/UL scheduling for itself. In other words, a Search Space (SS) for a PDCCH for scheduling scheduling/scheduled CCs which are in the CCS relation may exist in a control channel region of all the scheduling CCs.

Meanwhile, in the LTE system, FDD DL carrier or TDD DL subframes are configured to use first n (n<=4) OFDM symbols of each subframe for transmission of physical channels for transmission of various kinds of control information, wherein examples of the physical channels include a PDCCH, a PHICH, and a PCFICH. At this time, the number of OFDM symbols used for control channel transmission at each subframe may be delivered to the UE dynamically through a physical channel such as PCFICH or semi-statically through RRC signaling.

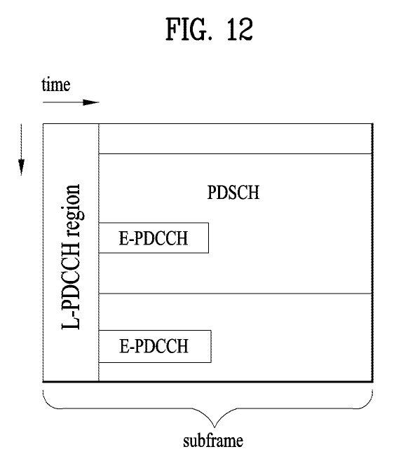

Meanwhile, in the LTE/LTE-A system, since a PDCCH which is a physical channel for DL/UL scheduling and transmitting various kinds of control information has a limitation that it is transmitted through limited OFDM symbols, Enhanced PDCCH (i.e., EPDCCH) multiplexed with a PDSCH more freely in a way of FDM/TDM may be introduced instead of a control channel such as PDCCH, which is transmitted through OFDM symbol and separated from PDSCH. FIG. 12 illustrates an example that legacy PDCCH, PDSCH and EPDCCH, which are used in an LTE/LTE-A system, are multiplexed.

4. Improved MTC Coverage

4.1 MTC UE

For an LTE-A system (beyond Rel-12) as a future-generation wireless communication system, it is under consideration to configure low-price/low-specification UEs that conduct mainly data communication such as metering, water level measurement, use of a surveillance camera, and stock reporting of a vendor machine. In embodiments of the present disclosure, such UEs will be referred to as MTC UEs.

MTC is a scheme of conducting communication between devices without human intervention. Smart metering may be considered to be a major application of MTC. Smart metering is an application technology of attaching a communication module to a metering device for measurement of electricity, gas, water, and so on, and transmitting measurement information periodically to a central control center or a data collection center.

Further, since MTC UEs are supposed to be produced and distributed at low prices, the MTC UEs may be designed to support only very narrow bands (e.g., equal to or less than 1RB, 2RBs, 3RBs, 4RBs, 5RBs, or 6RBs), compared to a general cellular system. In this case, an MTC UE is not capable of decoding a DL control channel region transmitted across a total system band as is done in the general cellular system, and control information for the MTC UE may not be transmitted in the DL control channel region. That is why the amount of control information for an MTC UE is decreased and the amount of resources for data transmission to the MTC UE is also decreased.

An MTC UE used for smart metering may have difficulty in communicating with an eNB because the MTC UE is highly likely to be installed in a shadowing area such as a basement. Accordingly, data needs to be transmitted repeatedly on a DL channel and/or a UL channel to overcome the difficulty. For example, the PDCCH/EPDCCH, PDSCH, PUSCH, and PUCCH may all be transmitted repeatedly.

To realize low-price MTC UEs, the bandwidth of the MTC UEs may be limited. That is, although a system bandwidth is 10 MHz, an MTC UE may transmit and receive signals only in 1.4 MHz. The present disclosure proposes a method for transmitting and receiving a Positioning Reference Signal (PRS) in a PRS subframe, a method for transmitting and receiving a PDSCH, and an operation of an MTC UE. Unless otherwise specified, the following embodiments of the present disclosure may be implemented based on the description of clauses 1 to 3.

4.2 Method for Improving MTC Coverage

Now, a description will be given of methods for improving coverage for MTC UEs.

4.2.1 TTI Bundling/HARQ Retransmission/Repeated Transmission/Code Spreading/RLC Segmentation/Low Rate Coding/Low Modulation Order/New Decoding Techniques

For MTC UEs, more energy may be accumulated to improve coverage by prolonging a transmission time. For example, the existing TTI bundling and HARQ retransmission in a data channel may be effective to MTC UEs. Since the current maximum number of UL HARQ retransmissions is 28 and TTI bundling is up to 4 consecutive subframes, TTI bundling with a larger TTI bundle size may be considered and the maximum number of HARQ retransmissions may be increased, to achieve better performance. Aside from TTI bundling and HARQ retransmission, the same or different RVs may be applied to repeated transmissions of data. In addition, code spreading in the time domain may also be considered to improve coverage.

MTC traffic packets may be RLC-segmented into smaller packets, and very low rate coding, a lower modulation order (e.g., BPSK), and a shorter-length CRC may also be used.

New decoding techniques (e.g. correlation or reduced SS decoding) may be used to improve coverage by taking into account the characteristics of particular channels (e.g., a channel periodicity, a parameter change rate, a channel structure, limited content, etc.).

4.2.2 Power Boosting/Power Density Spectrum (PDS) Boosting

The eNB may transmit, to an MTC UE, DL data with more power (i.e., power boosting), or at a given power level in a reduced bandwidth (i.e., PSD boosting). The application of power boosting or PSD boosting depends on the channel or signal under consideration.

4.2.3 Relaxed Requirement

The performance requirements for some channels may be relaxed considering the characteristics (e.g., greater delay tolerance) of MTC UEs in extreme scenarios. For the Synchronization Signal (SS), MTC UEs may accumulate energy by combining Primary SS (PSS) or Secondary SS (SSS) a plurality of times, but this will prolong an acquisition time. For a PRACH, a loosened PRACH detection threshold rate and a higher false alarm rate at the eNB may be considered.

4.2.4 Design of New Channel or Signal

New design of channels or signals for better coverage is possible if implementation-based schemes cannot meet coverage improvement requirements. These channels and signals, together with other possible link-level solutions for coverage enhancement will be described below.

4.2.5 Small Cell for Coverage Improvement

Coverage enhancements using link improvements are preferably provided for scenarios in which no small cells have been deployed by an operator. That is, an operator may deploy traditional coverage improvement solutions using small cells (including Pico, Femto, Remote Radio Heads (RRHs), relays, repeaters, etc.) to provide coverage enhancements to MTC UEs and non-MTC UEs alike. In deployments of small cells, a path loss from a UE to the closest cell is reduced. As a result, for MTC UEs, a required link budget may be reduced for all channels. Depending on the small cell location/density, the coverage enhancement may still be required.

For eNB deployments that already contain small cells, there may be a benefit to further allow decoupled UL and DL for delay-tolerant MTC UEs. For UL, the best serving cell is chosen based on a least coupling loss. For DL, due to large transmission power imbalance (including antenna gains) between a macro cell and a Low Power Node (LPN), the best serving cell is one with a maximum received signal power. This UL/DL decoupled association is feasible for MTC traffic especially for services without tight delay requirements.

To enable a UL/DL decoupled operation either in a UE-transparent or non-transparent manner, a macro serving cell and potential LPNs may need to exchange information for channel (e.g. RACH, PUSCH, and SRS) configurations and to identify a suitable LPN. A different RACH configuration from that of non-decoupled UL/DL may be needed for decoupled UL/DL.

Possible link-level solutions for coverage enhancement of various physical channels and signals are summarized in [Table 4].

TABLE 4

| | Channels/Signals | | | | | |
|---|---|---|---|---|---|---|
| | | | | | PDSCH/ | |
| Solutions | PSS/SSS | PBCH | PRACH | (E)PDCCH | PUSCH | PUCCH |
| PSD boosting | x | x | x | x | x | |
| Relaxed requirement | x | | x | | | |
| Design new channels/ | x | x | x | x | x | |
| signals | | | | | | |
| Repetition | | x | x | x | x | x |
| Low rate coding | | x | | x | x | x |
| TTI bundling/Retransmission | | | | | x | |
| Spreading | | x | | | x | |
| RS power boosting/ | | x | | x | x | |
| increased RS density | | | | | | |
| New decoding techniques | | x | | | | |

5. PBCH Transmission Method for MTC UE

5.1 MTC UE

The next generation system of LTE-A considers constructing UEs of low cost/low specification which mainly perform data communication for, for example, meter reading, measurement of water level, utilization of a surveillance camera, stock report about a vending machine, and the like. For simplicity, such UEs will be referred to as machine type communication (MTC) UEs in the embodiments of the present invention.

For an MTC UE, the amount of transmitted data is small, and UL/DL data transmission/reception occasionally occurs. Accordingly, it is preferable to reduce the cost per UE and battery consumption according to such low data transmission rate in terms of efficiency. The MTC UE has low mobility, and thus the channel environment thereof is almost invariable. In the current LTE-A, expanding the coverage of the MTC UE compared to the conventional cases is under consideration. To this end, various coverage enhancement techniques for the MTC UE are under discussion.

For example, when an MTC UE performs initial access to a specific cell, the MTC UE may receive a master information block (MIB) for the cell from an eNodeB (eNB) operating/controlling the cell over a Physical Broadcast Channel (PBCH) and receive system information block (SIB) information and radio resource control (RRC) parameters over a PDSCH.

The MTC UE may be installed in a region (e.g., a basement, etc.) providing a poor transmission environment compared to the legacy UE, and thus if the eNodeB transmits an SIB to the MTC UE using the same method as used for the legacy UE, the MTC UE may have difficulty in receiving the SIB. To address this difficulty, the eNB may apply coverage enhancement techniques such as subframe repetition and subframe bundling in transmitting the PBCH or SIB to an MTC UE having a coverage issue over a PDSCH.

In addition, if the eNB transmits a PDCCH and/or a PDSCH to MTC UEs using the same method as used for the legacy UE, an MTC UE having a coverage issue has difficulty in receiving the PDCCH and/or PDSCH. To address this difficulty, the eNB may repeatedly transmit the PBCH to the MTC UE having the coverage issue.

5.2 Methods for Repeatedly Transmitting PBCH

Hereinafter, a description will be given of methods for repeatedly transmitting the PBCH described in section 3, for an MTC UE.

The payload of the PBCH includes a downlink system bandwidth, PHICH configuration information and/or system frame number (SFN) information. The eNB adds CRC to the PBCH payload, performs ⅓ tail-biting convolutional coding, and then transmits the PBCH.

The PBCH is transmitted in the unit of 4 radio frames (40 ms). For example, the PBCH is transmitted through 4 OFDM symbols in the second slot of subframe #0 of radio frame #0. The number of encoded bits of the PBCH transmitted at each PBCH transmission moment is 480 bits. Accordingly, 1920 encoded bits are transmitted through four transmissions. For simplicity of description, it is assumed that the 1920 PBCH encoded bits are configured by PBCH(0), PBCH(1), PBCH(2) and PBCH(3) which are concatenated and have the same size of 480 bits (see FIG. 8). Herein, PBCH (k mod 4) indicates PBCH encoded bits having the size of 480 bits transmitted on one OFDM symbol.

5.2.1 Method for Configuring PBCH for MTC UE

Hereinafter, a description will be given of a method for configuring a PBCH in the case where a PBCH transmission region and a legacy PBCH transmission region are differently configured for the MTC UE.

When a PBCH is transmitted at a position (e.g., the first slot of subframe #0 or another subframe) different from the second slot of subframe #0 (see FIG. 8), one encoded bit block may be selected and transmitted from among the 4 PBCH encoded bit blocks. When the position of transmission is different from the second slot of subframe #0, the number of resource elements (REs) for transmission of the selected PBCH encoded block depends on whether or not a cell reference signal (CRS) a channel status information-reference signal (CSI-RS), PDCCH, PHICH and/or PCFICH are transmitted.

In this case, information about the transmission region in which the PBCH encoded bit block is transmitted may be information pre-configured in the system or may be set to a position operatively connected with a PCID acquired over a synchronization channel.

Based on the descriptions given above, the following methods may be used to configure a PBCH encoded bit block. For simplicity of description, it is assumed that PBCH(1) is selected and transmitted from among the four PBCH encoded bit blocks. The same methods may also be applicable when the other PBCH encoded bit blocks are selected.

(1) Method 1

If the number of REs for transmitting the PBCH encoded bit block in a corresponding subframe is less than 240, not all of the PBCH(1) having the size of 480 bits can be transmitted. Accordingly, bits are transmitted on the available REs starting with the first bit, and then the remaining bit string of PBCH(1) is not transmitted.

(2) Method 2

If the number of REs for transmitting the PBCH encoded bit block in a corresponding subframe is greater than 240, the available REs may be more than necessary REs for transmission of the whole PBCH(1) having the size of 480 bits. Therefore, the eNB may retransmit the first part of PBCH(1) on the remaining available REs in a cycling manner.

(3) Method 3

If the number of REs for transmitting the PBCH encoded bit block in a corresponding subframe is greater than 240, the available REs may be more than necessary REs for transmission of the whole PBCH(1) having the size of 480 bits. Therefore, the eNB may transmit the first part of PBCH(2), which is the next PBCH encoded bit block, on the remaining available REs.

(4) Method 4

If the number of REs for transmitting the PBCH encoded bit block in a corresponding subframe is greater than 240, the eNB transmits the entirety of PBCH(1) having the size of 480 bits in the corresponding frame. Then, the eNB may not transmit anything on the remaining REs in the subframe.

(5) Method 5

If the number of REs for transmitting the PBCH encoded bit block in a corresponding subframe is greater than 240, the eNB may be configured to transmit the first part of a specific pre-configured PBCH encoded bit block (e.g., PBCH(0)) on the remaining available REs other than the REs used for transmission of the PBCH(1), regardless of the selected PBCH encoded bit block.

That is, an MTC PBCH transmitted through a resource region different from the legacy PBCH transmission region may be configured as illustrated in Methods 1 to 5, according to the size of a resource region allocated to each subframe.

In addition, the legacy PBCH transmission region may be configured by 6 resource blocks (RBs) at the center frequency of the second slot of the first subframe in every frame, and the MTC PBCH transmission region may be allocated in the second, third and/or fourth subframes in every frame. Herein, the size of the MTC PBCH transmission region may change according to the CSI-RS and CRS configured in each cell. That is, the PBCH may be configured using Method 1 if the size of the transmission region of the MTC PBCH is less than 240 REs, may be configured using one of or a combination of one or more of Methods 2 to 5 if the size of the transmission region is greater than or equal to 240 REs.

5.2.2 Method for Transmitting MTC PBCH in Consideration of Transmission of legacy PBCH

According to embodiments of the present invention, an MTC PBCH encoded bit block for an MTC UE may be repeatedly transmitted on time/frequency resources different from the position at which a legacy PBCH for normal UE is transmitted (see FIG. 8). That is, in embodiments of the present invention described below, it is basically assumed that the legacy PBCH and the MTC PBCH contain the same MIB. However, as described in FIG. 8, the legacy PBCH is transmitted through a resource region defined in the LTE/LTE-A system (i.e., a legacy resource region), and the MTC PBCH is repeatedly transmitted for the MTC UE in a region other than the legacy resource region.

An exemplary method for selecting a PBCH encoded bit block is shown in Table 5 below. Here, it is assumed that transmission of the PBCH encoded bit block is repeated once on a resource (e.g., the second slot of subframe #1) other than the resources for the legacy PBCH.

TABLE 5

| | Radio frame #0 | | Radio frame #1 | | Radio frame #2 | | Radio frame #3 | |
|---|---|---|---|---|---|---|---|---|
| | Subframe | Subframe | Subframe | Subframe | Subframe | Subframe | Subframe | Subframe |
| | #0 | #1 | #0 | #1 | #0 | #1 | #0 | #1 |
| PBCH | PBCH(0) | PBCH(2) | PBCH(1) | PBCH(3) | PBCH(2) | PBCH(0) | PBCH(3) | PBCH(1) |
| encoded | | or | | or | | or | | or |
| bit block | | PBCH(3) | | PBCH(2) | | PBCH(1) | | PBCH(0) |

In Table 5, legacy PBCH encoded bit blocks may be transmitted in the first subframe (subframe #0) in each radio frame, and the MTC PBCH encoded bit blocks to be repeatedly transmitted for the MTC UE may be transmitted in the second subframe (subframe #1) in each radio frame. Thereby, the eNB may transmit all PBCH encoded bit blocks within as short a time as possible.

Alternatively, the eNB may retransmit a PBCH encoded bit block identical to the last PBCH encoded bit block previously transmitted in the resource region of the legacy PBCH.

TABLE 6

| | Radio frame #0 | | Radio frame #1 | | Radio frame #2 | | Radio frame #3 | |
|---|---|---|---|---|---|---|---|---|
| | Subframe | Subframe | Subframe | Subframe | Subframe | Subframe | Subframe | Subframe |
| | #0 | #1 | #0 | #1 | #0 | #1 | #0 | #1 |
| PBCH | PBCH(0) | PBCH(0) | PBCH(1) | PBCH(1) | PBCH(2) | PBCH(2) | PBCH(3) | PBCH(3) |
| encoded | | | | | | | | |
| bit block | | | | | | | | |

Referring to Table 6, legacy PBCH encoded bit blocks may be transmitted in the first subframe (subframe #0) in each radio frame, and an MTC PBCH encoded bit block identical to the PBCH encoded bit block transmitted for the MTC UE in the first subframe may be repeatedly transmitted in the second subframe (subframe #1). If the PBCH is transmitted using the method of Table 6, reliability and reception rate of PBCH transmission may be enhanced.

That is, Table 6 shows that the same PBCH encoding bit block is repeated in the same radio frame. In addition, by doing so, frequency tracking can be easily performed. In other words, the eNB can perform the frequency tracking efficiently by transmitting the same PBCH encoding bit block in the same radio frame. Therefore, when the same PBCH encoding bit block is repeatedly transmitted in the same frame, a constant phase difference value can be obtained, thereby helping frequency offset estimation.

Table 7 illustrates repeatedly transmitting an MTC PBCH twice at positions different from the resource region for transmission of the legacy PBCH using the method of Table 3.

TABLE 7

| | | PBCH encoded bit block |
|---|---|---|
| Radio frame #0 | Subframe #0 | PBCH(0) |
| | Subframe #1 | PBCH(2) or PBCH(3) |
| | Subframe #2 | PBCH(3) or PBCH(2) |
| Radio frame #1 | Subframe #0 | PBCH(1) |
| | Subframe #1 | PBCH(0) or PBCH(3) |
| | Subframe #2 | PBCH(3) or PBCH(0) |
| Radio frame #2 | Subframe #0 | PBCH(2) |
| | Subframe #1 | PBCH(1) or PBCH(0) |
| | Subframe #2 | PBCH(0) or PBCH(1) |
| Radio frame #3 | Subframe #0 | PBCH(3) |
| | Subframe #1 | PBCH(2) or PBCH(1) |
| | Subframe #2 | PBCH(1) or PBCH(2) |

Referring to Table 7, legacy PBCH encoded bit blocks may be transmitted in the first subframe (subframe #0) in each radio frame, and the MTC PBCH encoded bit blocks to be repeatedly transmitted for the MTC UE may be transmitted in the second subframe (subframe #1) and the third subframe (subframe #2) in each radio frame.

That is, with the methods according to Tables 5 to 7, the MTC UE to stably receive PBCH by decoding both the legacy region and the region in which MTC PBCH encoded bit blocks are transmitted. Herein, the region in which the MTC PBCH is prenotified to the UE through a higher layer signal or may be predetermined in the system. In addition, for the legacy UE, MIB may be acquired by decoding only the legacy PBCH transmission region.

In addition, if the MTC PBCH is repeatedly transmitted three or more times, an MTC PBCH encoded bit block may be transmitted in the fourth subframe. In this case, all four PBCH encoded bit blocks may be transmitted in the first to fourth subframes in one frame.

5.3 Extension of PBCH Transmission Method

In the legacy system, a PBCH is repeatedly transmitted across four subframes. However, the PBCH transmission is performed such that a single bit block is converted into four PBCH encoding bit blocks through processing processes such as modulation, scrambling, cyclic prefix, etc. and then the four PBCH encoding bit blocks are transmitted. In the embodiments of the present invention, repeated MTC PBCH transmission for an MTC UE means that some or all of the four PBCH encoding bit blocks are repeatedly transmitted with predetermined times to the MTC UE.

Hereinafter, a description will be given of a method for configuring a PBCH when a PBCH transmission region for an MTC UE is different from a legacy PBCH transmission region. In particular, the legacy PBCH transmission region is configured with 6 RBs at the center of the second slot of subframe #0 of each frame. In the case, the repeated PBCH transmission for the MTC UE is basically performed in the same subframe but in some cases, it can be performed in a region except the legacy PBCH transmission region or a different subframe.

5.3.1 First Method

The eNB may be configured to perform the repeated PBCH transmission for the MTC UE in subframe #0 (SF #0) including the legacy PBCH transmission region. For example, when the eNB repeatedly transmits PBCH(0) corresponding to a PBCH encoding bit block for the MTC UE in the legacy PBCH transmission region of SF#0, the eNB repeatedly transmits a different PBCH (e.g., PBCH(1), PBCH(2), or PBCH(3)) rather than PBCH(0) in a region except the legacy PBCH transmission region of SF#0.

In addition, the eNB may be configured to repeatedly transmit PBCH(0) for the MTC UE in a different SF except SF#0 in which the legacy PBCH is transmitted. In this case, when the PBCH is relatedly transmitted in the different SF except SF#0, the eNB may perform the repeated PBCH transmission starting from a point where transmission of a specific PBCH encoding block (e.g., PBCH(1)) is terminated to next PBCH encoding blocks (e.g., PBCH(2) and PBCH(3)) according to the number of REs allocated for the repeated PBCH transmission.

In this case, a point where repeated transmission of the PBCH (1) is terminated may be changed depending on the number of REs allocated for the repeated PBCH transmission. That is, the point may be a point where part of PBCH(1) is not transmitted or a point where part of PBCH(2) is transmitted.

5.3.2. Second Method

If the eNB transmits PBCH(0) in SF#0 in which the legacy PBCH is transmitted, the eNB may transmit PBCH(1) in the same SF for the repeated PBCH transmission. In addition, the eNB may transmit PBCH encoding bit blocks to be repeatedly transmitted in other SFs except SF#0 from a starting point of PBCH(2) in an order of PBCH(3) and PBCH(0) according to the number of REs allocated for the repeated PBCH transmission.

For example, if the eNB transmits PBCH(0) for the MTC UE in the legacy PBCH transmission region of SF#0, the eNB may repeatedly transmit PBCH(1) corresponding to the PBCH encoding bit block next to PBCH(0) in a region except the legacy PBCH transmission region of SF#0.

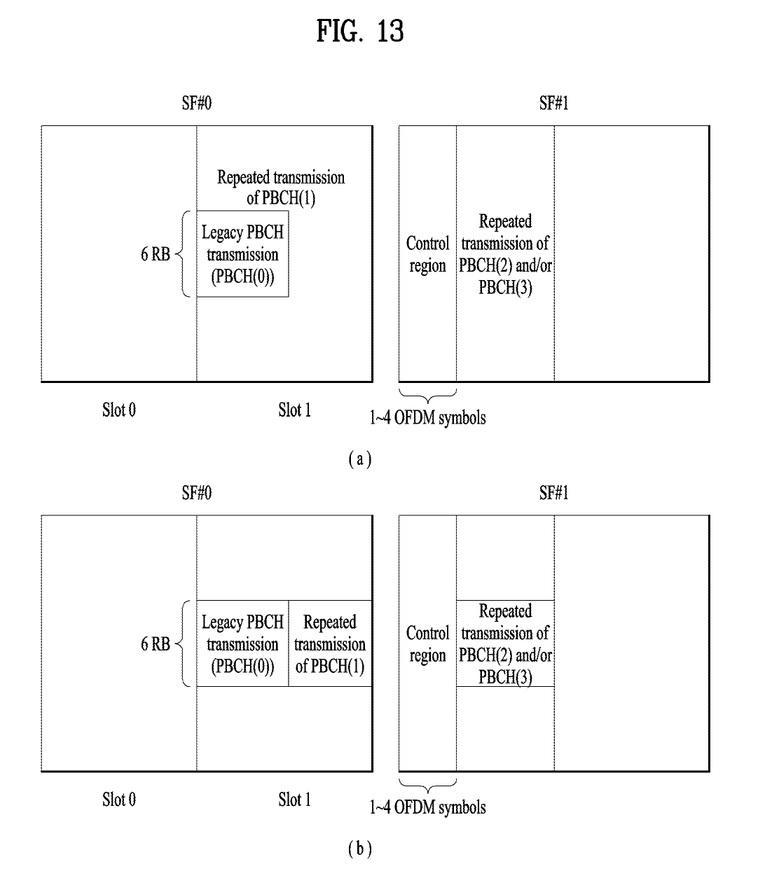

FIG. 13 is a diagram for explaining a method performed by a BS for repeatedly transmitting a PBCH to an MTC UE.

The first and second methods can be applied to the following embodiment, which will be described. Referring to FIG. 13, the eNB may repeatedly transmit the PBCH encoding bit block PBCH(0) in the legacy PBCH region to the MTC UE. In this case, the legacy PBCH region is allocated to subframes corresponding to 6 RBs at the center frequency of the second slot (slot #1) of the first subframe (SF#0) of each frame and 4 OFDM symbols.

In this case, it is preferable that the PBCH encoding bit block transmitted in the legacy PBCH region is different from PBCH encoding bit blocks transmitted in other regions. For example, referring to FIG. 13 (a), when transmitting the PBCH encoding bit block PBCH(0) in the legacy PBCH region of SF#0, the eNB can repeatedly transmit PBCH(1), PBCH(2), or PBCH(3) in other regions. FIG. 13(b) shows a case in which only the center 6 RBs in the frequency domain are allocated for the MTC UE. That is, a region used by the eNB to transmit the PBCH to the MTC UE may be limited to the center 6 RBs.

In addition, if the repeated transmission of the PBCH encoding bit block for the MTC UE is not completed, the eNB may transmit the remaining PBCH encoding bit blocks in another SF except SF#0 to which the legacy PBCH transmission region is allocated. For example, referring to FIGS. 13(a) and 13(b), PBCH(2) and/or PBCH(3) can be repeatedly transmitted in SF#1.

Moreover, in the first method described in the section 5.3, transmission order of the PBCH encoding bit block transmitted in the legacy PBCH transmission region and the PBCH encoding bit blocks repeatedly transmitted in other regions except the legacy PBCH transmission region can be configured in a random manner. On the contrary, in the second method, the PBCH encoding bit blocks are transmitted in a predetermined order. For example, when PBCH(0) is transmitted in the legacy PBCH transmission region, PBCH(1), PBCH(2), and PBCH(3) may be repeatedly transmitted in other regions in a sequential manner.

The PBCH transmission architecture described with reference to FIG. 13 can be used in an environment where the legacy UE and the MTC UE coexist. For example, it can be configured that the PBCH transmitted in the legacy PBCH transmission region is decoded by both of the legacy UE and the MTC UE but PBCHs transmitted in other regions except the legacy PBCH transmission region are decoded by only the MTC UE.

Alternatively, the PBCH transmission architecture described in FIG. 13 can be used only for the MTC UE. In this case, the PBCH for the MTC UE can be repeatedly transmitted even in the legacy PBCH transmission region. Since the PBCH for the MTC UE carries a small amount of information compared to a PBCH for the legacy UE, the PBCH for the MTC UE can be repeatedly transmitted in the legacy PBCH transmission region.

5.4 Limitation of Region in which PBCH is Repeatedly Transmitted

5.4.1 Limitation of Control Region

If the PBCH is repeatedly transmitted in a resource region except the second slot of SF#0 or in the first slot (e.g., slot #0) of another SF, the PBCH may be transmitted in OFDM symbols except OFDM symbols used for PDCCH transmission.

In this case, since the MTC UE cannot decode a legacy PDCCH, the MTC UE cannot obtain information on OFDM symbols used for transmission of the legacy PDCCH. Therefore, it is preferred that the MTC UE receives the repeatedly transmitted PBCH encoding bit blocks by assuming that a predetermined number of OFDM symbols are used for the PDCCH transmission.

For example, the MTC UE can assume that a predetermined number of OFDM symbols (e.g., three OFDM symbols) are used for transmitting the legacy PDCCH irrespective of the number of actual OFDM symbols used for transmitting the PDCCH. In other words, the MTC UE can receive and decode the PBCH by assuming that the repeated PBCH transmission is started from the fourth OFDM symbol. In this case, it is preferable to assume the number of OFDM symbols used for the legacy PDCCH transmission to be equal to or smaller than four.

Referring to FIGS. 13(a) and 13(b), when the PBCH is repeatedly transmitted in another SF except SF#0, a control region to which the legacy PDCCH is allocated may be excluded from the region in which the PBCH is repeatedly transmitted. In other words, the MTC UE can assume that the PBCH is not transmitted in the predetermined number of OFDM symbols considered as the control region and then perform decoding on PBCH encoding bit blocks repeatedly transmitted in a data region except the control region.

5.4.2 Limitation of RS Allocation Region

In the embodiments of the present invention, the repeated PBCH transmission may not be performed on an RE where a CSI-RS can be transmitted according to a CSI-RS configuration.

In this case, the CSI-RS configuration may assume a CSI-RS RE included in the configuration commonly used in both the FDD and TDD. Referring to Table 6.10.5.2-1 in 3GPP TS 36.211 document, in the normal CP system, CSI-RS configuration indices #0 to #19 are commonly used in both the FDD and TDD. For example, in the first slot of an SF, a CSI-RS is transmitted in the sixth and seventh OFDM symbols and in the second slot of the SF, a CSI-RS is transmitted in the third and fourth OFDM symbols or the sixth and seventh OFDM symbols.

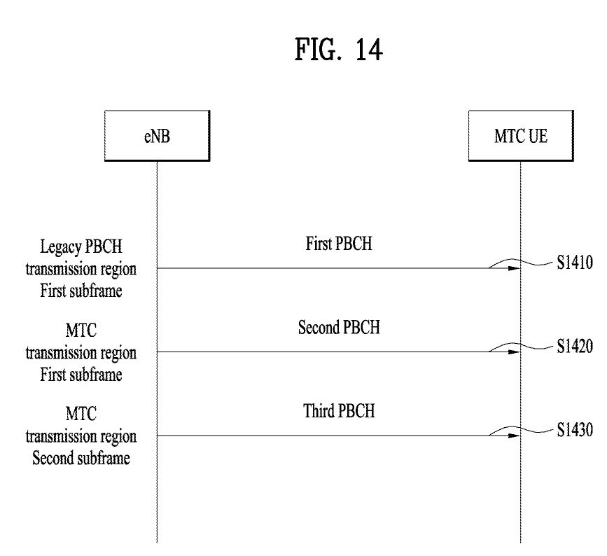

FIG. 14 is a diagram for explaining a method for repeatedly transmitting an MTC PBCH to an MTC UE.

In FIG. 14, an eNB can repeatedly transmit a first PBCH (e.g., PBCH(0)) corresponding to a PBCH encoding bit block in a legacy PBCH transmission region of a first subframe (e.g., SF#0) to an MTC UE [S1410].

Thereafter, the eNB can repeatedly transmit a second PBCH (e.g., PBCH(1), PBCH(2), or PBCH(3)) corresponding to a PBCH encoding bit block in an MTC transmission region of the first subframe to the MTC UE [S1420].

If the eNB fails to repeatedly transmit sufficient PBCH encoding bit blocks to the MTC UE in the step S1420, the eNB can repeatedly transmit remaining PBCH encoding bit blocks (e.g., PBCH(1), PBCH(2), or PBCH(3)) in a second subframe (e.g., SF#1), which is different from the first subframe, to the MTC UE [S1430].

In the embodiments of the present invention, the MTC transmission region may mean a transmission region allocated for the MTC UE. For example, the MTC transmission region may be configured with the center 6 RBs of a specific subframe or each subframe.

The methods described above in the sections 1 to 5 can be applied to the method described with reference to FIG. 14. In particular, in the case of the repeated PBCH transmission for the MTC UE, the methods described in the section 5 can be applied. For example, the legacy PBCH transmission region and the MTC transmission region described with reference to FIG. 13 can be applied. In addition, when the PBCH is not transmitted in the legacy PBCH transmission region, it may be configured that the PBCH is not transmitted in the control region or the region where the RS is transmitted.

6. Apparatuses

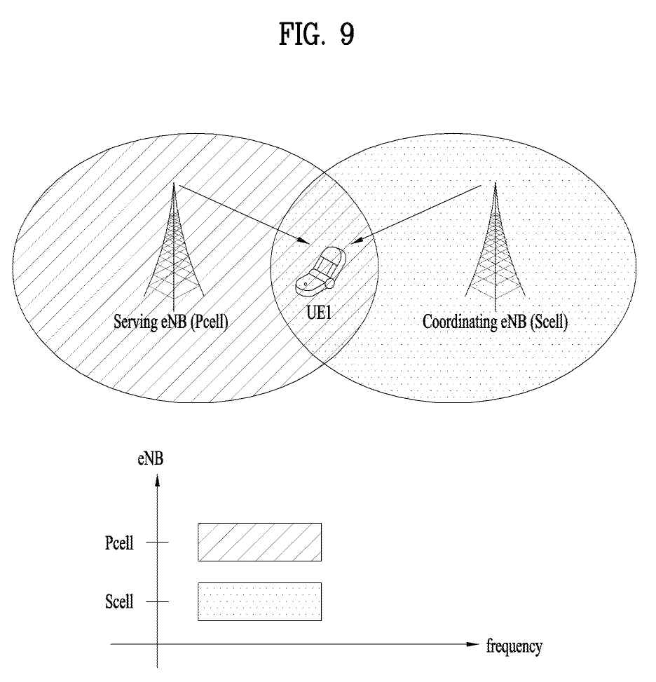

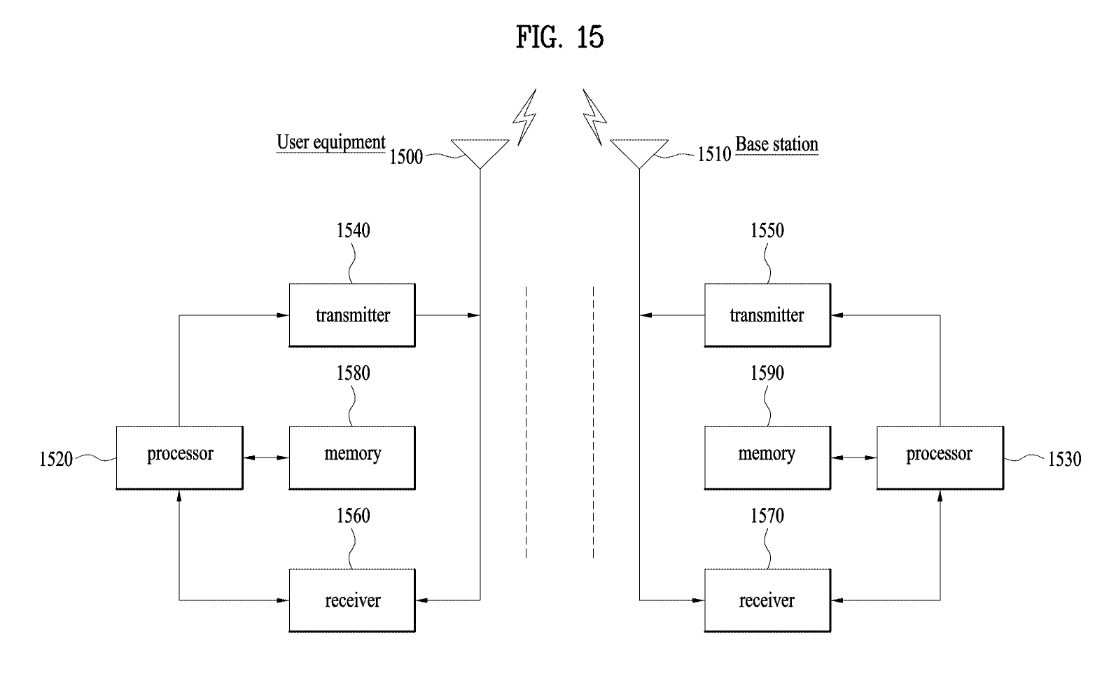

Apparatuses illustrated in FIG. 15 are means that can implement the methods described before with reference to FIGS. 1 to 14.

A UE may act as a transmission end on a UL and as a reception end on a DL. A BS may act as a reception end on a UL and as a transmission end on a DL.

That is, each of the UE and the BS may include a Transmitter (Tx) 1540 or 1550 and Receiver (Rx) 1560 or 1570, for controlling transmission and reception of information, data, and/or messages, and an antenna 1500 or 1510 for transmitting and receiving information, data, and/or messages.

Each of the UE and the BS may further include a processor 1520 or 1530 for implementing the afore-described embodiments of the present invention and a memory 1580 or 1590 for temporarily or permanently storing operations of the processor 1020 or 1030.

The embodiments of the present invention can be implemented based on the above-described components and functions of the UE and the BS. For example, the processor of the BS can perform repeated PBCH transmission by controlling the transmitter. In particular, the processor of the BS may repeatedly transmit a PBCH to an MTC UE not only in a legacy PBCH transmission region but also in subframe equal to or different from a subframe including the legacy PBCH transmission region for the repeated PBCH transmission. In this case, if the PBCH is transmitted in the subframe different from the subframe including the legacy PBCH transmission region, the processor of the BS may be configured not to transmit the PBCH in a control region where a PDCCH is transmitted or REs where a reference signal (e.g., cell-specific and/or UE-specific reference signals) is transmitted. The processor of UE can decode the corresponding subframes and then receive the PBCH by assuming that the PBCH is not transmitted in such limited regions. The above-described operations can be applied to the embodiments of the present invention, which are described in the sections 1 to 5.

The Tx and Rx of the UE and the BS may perform a packet modulation/demodulation function for data transmission, a high-speed packet channel coding function, OFDMA packet scheduling, TDD packet scheduling, and/or channelization. Each of the UE and the BS of FIG. 15 may further include a low-power Radio Frequency (RF)/Intermediate Frequency (IF) module.

Meanwhile, the UE may be any of a Personal Digital Assistant (PDA), a cellular phone, a Personal Communication Service (PCS) phone, a Global System for Mobile (GSM) phone, a Wideband Code Division Multiple Access (WCDMA) phone, a Mobile Broadband System (MBS) phone, a hand-held PC, a laptop PC, a smart phone, a Multi Mode-Multi Band (MM-MB) terminal, etc.

The smart phone is a terminal taking the advantages of both a mobile phone and a PDA. It incorporates the functions of a PDA, that is, scheduling and data communications such as fax transmission and reception and Internet connection into a mobile phone. The MB-MM terminal refers to a terminal which has a multi-modem chip built therein and which can operate in any of a mobile Internet system and other mobile communication systems (e.g. CDMA 2000, WCDMA, etc.).

Embodiments of the present invention may be achieved by various means, for example, hardware, firmware, software, or a combination thereof.

In a hardware configuration, the methods according to exemplary embodiments of the present invention may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the methods according to the embodiments of the present invention may be implemented in the form of a module, a procedure, a function, etc. performing the above-described functions or operations. A software code may be stored in the memory 1580 or 1590 and executed by the processor 1540 or 1530. The memory is located at the interior or exterior of the processor and may transmit and receive data to and from the processor via various known means.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein. It is obvious to those skilled in the art that claims that are not explicitly cited in each other in the appended claims may be presented in combination as an embodiment of the present invention or included as a new claim by a subsequent amendment after the application is filed.

### INDUSTRIAL APPLICABILITY

Embodiments of the present invention are applicable to various wireless access systems including a 3GPP system, a 3GPP2 system, and/or an IEEE 802.xx system. In addition to these wireless access systems, the embodiments of the present invention are applicable to all technical fields in which the wireless access systems find their applications.

1-14. (canceled)

15. A method for repeatedly transmitting a physical broadcast channel (PBCH) for a user equipment (UE) in a wireless access system, the method performed by an evolved Node-B (eNB) and comprising:
transmitting a first PBCH at a legacy PBCH transmission region of a first subframe; and
repeatedly transmitting a second PBCH at a different region from the legacy PBCH transmission region in the first subframe and a second subframe,
wherein the first subframe is contiguous with the second subframe,
wherein the repeated second PBCHs are configured based on the first PBCH, and
wherein the second PBCHs are configured not to be transmitted at resource regions where a physical downlink control channel (PDCCH) is transmitted of the first and second subframes.

16. The method according to claim 15, wherein the resource regions are configured up to 3 OFDM symbols from a starting OFDM symbol of the first and the second subframes.

17. The method according to claim 15, wherein the second PBCHs are not allocated to reference resources (REs) reserved for a channel status information reference signal (CSI-RS).

18. The method according to claim 15, wherein the first PBCH is transmitted to a first UE which is a normal UE and the second PBCH is transmitted to a second UE which is a machine type communication (MTC) UE, and
wherein the second UE is configured to repeatedly transmit and/or receive control information and/or data.

19. The method according to claim 15, wherein the second PBCHs are repeatedly transmitted by a frame unit for four frames.

20. A method for repeatedly receiving a physical broadcast channel (PBCH) for a user equipment (UE) in a wireless access system, the method performed by the UE and comprising:
receiving a second PBCH at a different region from a legacy PBCH transmission region in a first subframe; and
receiving the second PBCH in a second subframe,
wherein the first subframe is contiguous with the second subframe,
wherein a first PBCH is transmitted at the legacy PBCH region of the first subframe,
wherein the repeatedly received second PBCHs are configured based on the first PBCH, and
wherein the second PBCHs are configured not to be repeatedly transmitted at resource regions where a physical downlink control channel (PDCCH) is transmitted of the first and second subframes.

21. The method according to claim 20, wherein the resource regions are configured up to 3 OFDM symbols from a starting OFDM symbol of the first and the second subframes.

22. The method according to claim 20, wherein the second PBCHs are not allocated to reference resources (REs) reserved for a channel status information reference signal (CSI-RS).

23. The method according to claim 20, wherein the first PBCH is transmitted to a first UE which is a normal UE and the second PBCH is transmitted to a second UE which is a machine type communication (MTC) UE, and
wherein the second UE is configured to repeatedly transmit and/or receive control information and/or data.

24. The method according to claim 20, wherein the second PBCHs are repeatedly transmitted by a frame unit for four frames.

25. An evolved Node-B (eNB) for repeatedly transmitting a physical broadcast channel (PBCH) for a user equipment (UE) in a wireless access system, the eNB comprising:
a transmitter; and
a processor,
wherein the processor controls the transmitter to:
transmit a first PBCH at a legacy PBCH transmission region of a first subframe; and
repeatedly transmit a second PBCH at a different region from the legacy PBCH transmission region in the first subframe and a second subframe,
wherein the first subframe is contiguous with the second subframe,
wherein the repeated second PBCHs are configured based on the first PBCH, and
wherein the second PBCHs are configured not to be transmitted at resource regions where a physical downlink control channel (PDCCH) is transmitted of the first and second subframes.

26. The eNB according to claim 25, wherein the resource regions are configured up to 3 OFDM symbols from a starting OFDM symbol of the first and the second subframes.

27. The eNB according to claim 25, wherein the second PBCHs are not allocated to reference resources (REs) reserved for a channel status information reference signal (CSI-RS).

28. The eNB according to claim 25, wherein the first PBCH is transmitted to a first UE which is a normal UE and the second PBCH is transmitted to a second UE which is a machine type communication (MTC) UE, and
wherein the second UE is configured to repeatedly transmit and/or receive control information and/or data.

29. The eNB according to claim 25, wherein the second PBCHs are repeatedly transmitted by a frame unit for four frames.

30. A user equipment (UE) for repeatedly receiving a physical broadcast channel (PBCH) in a wireless access system, the UE comprising:
a receiver; and
a processor,
wherein the processor controls the receiver to:
receive a second PBCH at a different region from a legacy PBCH transmission region in a first subframe; and
receive the second PBCH in a second subframe,
wherein the first subframe is contagious with the second subframe,
wherein a first PBCH is transmitted at the legacy PBCH region of the first subframe,
wherein the repeatedly received second PBCHs are configured based on the first PBCH, and
wherein the second PBCHs are configured not to be repeatedly transmitted at resource regions where a physical downlink control channel (PDCCH) is transmitted of the first and second subframes.

31. The UE according to claim 30, wherein the resource regions are configured up to 3 OFDM symbols from a starting OFDM symbol of the first and the second subframes.

32. The UE according to claim 30, wherein the second PBCHs are not allocated to reference resources (REs) reserved for a channel status information reference signal (CSI-RS).

33. The UE according to claim 30, wherein the first PBCH is transmitted to a first UE which is a normal UE and the second PBCH is transmitted to a second UE which is a machine type communication (MTC) UE, and
wherein the second UE is configured to repeatedly transmit and/or receive control information and/or data.

34. The UE according to claim 30, wherein the second PBCHs are repeatedly transmitted by a frame unit for four frames.
